(19) United States
(12) Patent Application Publication
(10) Pub. No.: US 2017/0264883 A1
(43) Pub. Date: Sep. 14, 2017

(54) IMAGING SYSTEM, MEASUREMENT SYSTEM, PRODUCTION SYSTEM, IMAGING METHOD, RECORDING MEDIUM, AND MEASUREMENT METHOD

(71) Applicant: CANON KABUSHIKI KAISHA, Tokyo (JP)

(72) Inventor: Tadashi Hayashi, Yokohama-shi (JP)

(21) Appl. No.: 15/451,189

(22) Filed: Mar. 6, 2017

(30) Foreign Application Priority Data
Mar. 9, 2016 (JP) 2016-045148

(51) Int. Cl. H04N 13/02; G06K 9/00

(52) U.S. Cl. CPC H04N 13/0221; H04N 13/0253; H04N 13/0296; G06K 9/00664; G06K 2209/401; G06K 2209/19

(57) ABSTRACT

For obtaining two captured images suitable for a monocular stereoscopic method, without stopping the conveyance of a workpiece, a first pixel region is selected during the conveyance of the workpiece, and image capturing is performed. If it is determined that an image of a first mark member has been captured, a first pixel region is selected, and an image of the workpiece is captured.

Next, a second pixel region is selected, and image capturing is performed. If it is determined that an image of a second mark member has been captured, a second pixel region is selected, and an image of the workpiece is captured. Through the above imaging operation, two captured images to be used for three-dimensional measurement performed by the monocular stereoscopic method are acquired.

### BACKGROUND OF THE INVENTION

Field of the Invention

The aspect of the embodiments relates to a technique of capturing an image of a workpiece for three-dimensionally measuring a workpiece using a monocular stereoscopic method.

Description of the Related Art

Conventionally, there has been a system for conveying a workpiece (an object) using a conveyance device such as a robot and a belt conveyor. In many cases, the workpiece is at an arbitrary position or orientation with respect to the conveyance device during the conveyance of the workpiece. It is therefore general to measure the position or orientation of the workpiece, in front of the work position, appropriately correct the position or orientation of the workpiece, and then, start work. In addition, also in inspection, it is general to execute the inspection after correcting the position or orientation of the workpiece, and sending the corrected position or orientation to a station specialized in inspection.

At this time, in some cases, the workpiece is three-dimensionally measured using an image, for three-dimensionally correcting the position or orientation of the workpiece. In a three-dimensional measurement device, measurement is generally executed by two cameras. Nevertheless, in the case of using a plurality of cameras, the device grows in size, and becomes costly. Thus, there has been proposed a method of executing, using the monocular stereoscopic method, three-dimensional measurement by a more compact and lower cost device by combining a monocular camera and a horizontal movement device (Japanese Patent Laid-Open No. 2007-327824).

Meanwhile, in a stereoscopic method using two cameras, the larger the disparity is, that is, the more the two cameras are distant from each other, the accuracy increases. In the case of the monocular stereoscopic method, for obtaining two images with large disparity, an image of a workpiece is captured at positions in peripheral portions of an imaging viewing field (a field angle) that are distant from each other as far as possible. Nevertheless, if the workpiece goes out of (i.e., overruns) the field angle in the peripheral portions, an image including the workpiece cannot be obtained.

Thus, in the conventional monocular stereoscopic method, for surely capturing an image of the workpiece twice using the cameras, the workpiece is stopped twice with high positional accuracy in the field angle, and particularly in the peripheral portions. In addition, attention is to be paid to vibration of the workpiece that is caused when an image of the workpiece is captured.

In other words, because the workpiece is once stopped for image capturing, an operating time of the horizontal movement device becomes longer for acceleration, deceleration, stop, and vibration suppression incidental thereto, and a total time from supply to discharge of the workpiece becomes longer.

In addition, for preventing the workpiece from overrunning, it can be considered to obtain an accurate position of the workpiece using a position detector such as, for example, an interrupt sensor and a linear encoder, and obtain two captured images without stopping the conveyance of the workpiece. Nevertheless, if an image of the workpiece is to be captured twice at the peripheral portions of the field angles of the cameras, troublesome works such as the position adjustment of the cameras and the position detector, and adjustment for a trigger delay increase. In particular, when the workpiece moves at high speed, or a movement speed is not constant, adjustment is difficult, and the adjustment is repeatedly executed a number of times.

### SUMMARY OF THE INVENTION

In view of the foregoing, the aspect of the embodiments aims to obtain two captured images suitable for the monocular stereoscopic method, without stopping the conveyance of a workpiece.

An imaging system according to an aspect of the embodiments includes an image sensor having a plurality of pixels, and a control unit configured to control the image sensor, wherein the control unit executes first imaging processing of obtaining a first image in a first pixel region positioned on an upstream side in a conveyance direction of a target object, first determination processing of determining, based on the first image, whether an image of a mark on an upstream side in the conveyance direction that has been applied to the target object or a holding member holding the target object has been captured, first target object imaging processing of obtaining an image of the target object in a case where the image of the mark on the upstream side has been captured, second imaging processing of obtaining a second image in a second pixel region positioned on a downstream side in the conveyance direction of the target object, second determination processing of determining, based on the second image, whether an image of a mark on a downstream side in the conveyance direction that has been applied to the target object or the holding member has been captured, and second target object imaging processing of obtaining an image of the target object in a case where the image of the mark on the downstream side has been captured.

Further features of the disclosure will become apparent from the following description of exemplary embodiments (with reference to the attached drawings).

### BRIEF DESCRIPTION OF THE DRAWINGS

FIG. 1 is a schematic diagram illustrating a schematic configuration of a production system according to a first exemplary embodiment.

FIG. 2 is a plan view of a workpiece gripped by fingers of a robot hand viewed from a camera side, according to the first exemplary embodiment.

FIG. 3 is a block diagram illustrating an internal configuration of a camera according to the first exemplary embodiment.

FIG. 4 is a flowchart illustrating an imaging method according to the first exemplary embodiment.

FIGS. 5A to 5F are schematic diagrams for illustrating the imaging method according to the first exemplary embodiment.

FIG. 6 is a circuit diagram illustrating a determination circuit according to the first exemplary embodiment.

FIGS. 7A to 7D are schematic diagrams each illustrating a mark image on an image, and a pixel image-captured by a selected pixel region.

FIG. 8A is a principle diagram illustrating a three-dimensional measurement method using stereoscopic cameras. FIG. 8B is a principle diagram illustrating a three-dimensional measurement method using a monocular stereoscopic method.

FIG. 9 is a schematic diagram illustrating a schematic configuration of a production system according to a second exemplary embodiment.

FIGS. 10A to 10D are explanatory diagrams illustrating examples and principle of retroreflective members.

FIG. 11 is a block diagram illustrating an internal configuration of a camera according to the second exemplary embodiment.

FIG. 12 is a flowchart illustrating an imaging method according to the second exemplary embodiment.

FIGS. 13A to 13F are schematic diagrams for illustrating the imaging method according to the second exemplary embodiment.

FIG. 14 is a flowchart illustrating a measurement method according to a third exemplary embodiment.

FIGS. 15A and 15B are schematic diagrams each illustrating another example of a conveyance device.

FIG. 16 is a schematic diagram illustrating another example of first and second pixel regions.

FIG. 17 is a schematic diagram illustrating another example of a mark member.

FIGS. 18A to 18C are diagrams for illustrating determination processing in a determination circuit.

FIG. 19 is a block diagram illustrating a configuration of a control system of a production system in a case in which a control unit is formed by a computer.

### DESCRIPTION OF THE EMBODIMENTS

Exemplary embodiments of the disclosure will be described in detail below with reference to the drawings.

### First Exemplary Embodiment

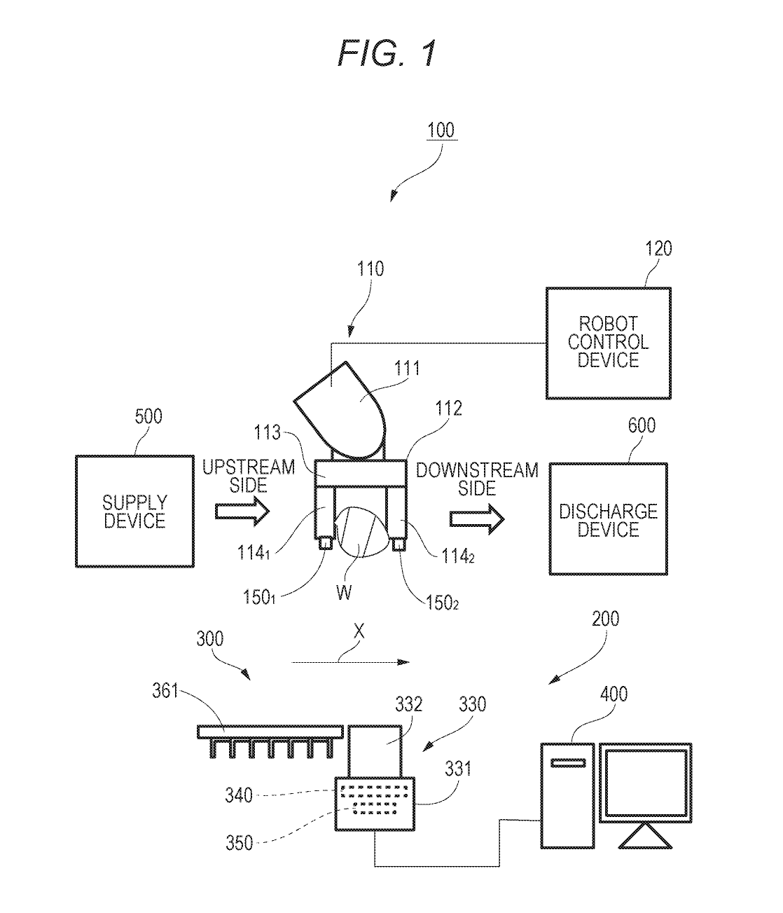

FIG. 1 is a schematic diagram illustrating a schematic configuration of a production system according to a first exemplary embodiment. A production system 100 includes a measurement system 200, a robot 110 serving as a conveyance device for conveying a workpiece W, a robot control device 120, a supply device 500 being an upstream side device, and a discharge device 600 being a downstream side device. The measurement system 200 includes an imaging system 300 and an image processing apparatus 400. The imaging system 300 includes a camera 330 being a monocular imaging apparatus, and a light source 361.

The robot 110 holds the workpiece W, and conveys the workpiece W in a conveyance direction X. The robot 110 has a robot arm 111 being a conveyance member (FIG. 1 illustrates only a leading edge portion of the robot arm 111), and a robot hand 112 being a holding member that is attached to the leading edge of the robot arm 111. The robot arm 111 moves the workpiece W in the conveyance direction X by moving the robot hand 112 holding the workpiece W, in the conveyance direction X.

The robot arm 111 is a vertical multijoint robot arm, and has a plurality of joints (e.g., 6 joints). The robot arm 111 is of a vertical multijoint type in the first exemplary embodiment, but may be any robot arm such as a horizontal multijoint robot arm, a parallel link robot arm, and a Cartesian coordinate robot.

The robot hand 112 has a hand main body 113 being a palm portion, and a plurality of (e.g., two) fingers 114₁ and 114₂ supported by the hand main body 113. The fingers 114₁ and 114₂ are driven by a driving mechanism (not illustrated) of the hand main body 113 in an opening or closing direction (direction to separate from or approach to the central axis of the hand main body 113.

By moving the fingers 114₁ and 114₂ in the closing direction, i.e., the direction to approach, the workpiece W can be gripped, and by moving the fingers 114₁ and 114₂ in the opening direction, i.e., the direction to separate, the workpiece W can be released from the gripping.

In addition, in the case of a ring-shaped workpiece, by moving the fingers 114₁ and 114₂ in the opening direction, a workpiece can be gripped while bringing the fingers 114₁ and 114₂ into contact with the inner surface of the workpiece. In addition, by moving the fingers 114₁ and 114₂ in the closing direction, the workpiece can be released from the gripping.

In this manner, the robot hand 112 can grip the workpiece W using the plurality of fingers 114₁ and 114₂. In addition, the configuration of the robot hand 112 is not limited to this. The robot hand 112 is able to hold the workpiece W. For example, the robot hand 112 may be of an adhesion type. In addition, the number of fingers is not limited to two, and may be three or more.

The camera 330 is a digital camera for automatically capturing an image of the workpiece W serving as an inspection measurement target. The image processing apparatus 400 three-dimensionally measures the state of the workpiece W from two captured images (data) sequentially acquired from the camera 330, and correction information that has been measured in advance. In the first exemplary embodiment, the description will be given of a case in which the image processing apparatus 400 obtains the position (or orientation) of the workpiece W from the captured images, as the state of the workpiece W. Nevertheless, a case of detecting a defect or the like of the workpiece W may be used.

The robot control device 120 controls an operation of the robot 110. Specifically, the robot control device 120 controls an operation of each joint of the robot arm 111, and an operation of the fingers 114₁ and 114₂ of the robot hand 112. In the robot control device 120, trajectory data of the robot 110 (the robot arm 111) is programmed so that the robot 110 passes through the inside of an imaging viewing field (a field angle) of the camera 330 in a direction parallel to a sensor surface of an image sensor 340, while the robot 110 is conveying the workpiece W. In other words, while maintaining a state in which a palm bottom surface (finger attaching surface) of the hand main body 113 is parallel to the sensor surface of the image sensor 340, the robot control device 120 drives the robot arm 111 to convey the workpiece W in the conveyance direction X parallel to the sensor surface of the image sensor 340. At this time, the robot control device 120 drives the robot arm 111 so that, among the two fingers 114₁ and 114₂ of the robot hand 112, one finger 114₁ is located on an upstream side in the conveyance direction X, and the other finger 114₂ is located on a downstream side in the conveyance direction X.

In addition, the robot control device 120 acquires, from the image processing apparatus 400, an image processing result, i.e., position data of the workpiece W with respect to the robot 110. The robot control device 120 corrects the orientation of the robot 110 based on the position data after the workpiece W has passed through the inside of the imaging viewing field of the camera 330. The robot control device 120 thereby corrects the position of the workpiece W, and discharges the workpiece W to the discharge device 600 on the downstream side. In addition, when causing the robot 110 to start an operation of conveying the workpiece W, the robot control device 120 outputs a start signal indicating that the operation of conveying the workpiece W is to be started, to the camera 330. In addition, the downstream side device is the discharge device 600 in this example, but the downstream side device may be another robot such as an assembly device.

The camera 330 has a camera main body 331 serving as an imaging unit, and a lens 332 attached to the camera main body 331. The camera main body 331 has the image sensor 340, and a control unit 350 for controlling the image sensor 340. The camera 330 is installed while being fixed on a stand (not illustrated) or the like. The light source 361 serving as an illumination device is, for example, a flash device (stroboscope) for emitting flashlight, and emits light onto the workpiece W when an image of the workpiece W is captured. The light source 361 is appropriately arranged at a position for realizing a bright field, a dark field, and the like, according to the processing details of the image processing apparatus 400. Mark members 150₁ and 150₂ being marks are installed at the respective leading edges of the two fingers 114₁ and 114₂ of the robot hand 112. Specifically, the mark member 150₁ is a first mark on an upstream side (a conveyance source side) in the conveyance direction X that has been applied to the finger 114₁ on the upstream side in the conveyance direction X of the robot hand 112. The mark member 150₂ is a second mark on a downstream side (conveyance destination side) in the conveyance direction X that has been applied to the finger 114₂ on the downstream side in the conveyance direction X of the robot hand 112. Images of the mark members 150₁ and 150₂ can be captured by the camera 330 when the mark members 150₁ and 150₂ pass through the inside of the field angle of the camera 330 during the conveyance, irrespective of a gripping state of the workpiece W.

In addition, the adjustment of an imaging timing at which an image of the workpiece W is captured is executed by a logic circuit in the camera 330, which will be described later. Thus, the camera 330 does not have to input a trigger signal for determining the imaging timing that has been issued from the image processing apparatus 400, the robot control device 120, or another higher controller.

In the first exemplary embodiment, using a monocular stereoscopic method, an image of the workpiece W being conveyed is captured at different angles using the single camera 330, and three-dimensional measurement is performed using two captured images. Different imaging timings at which the two captured images are to be obtained are determined using a detection result of the mark members 150₁ and 150₂ that is obtained by the image sensor 340.

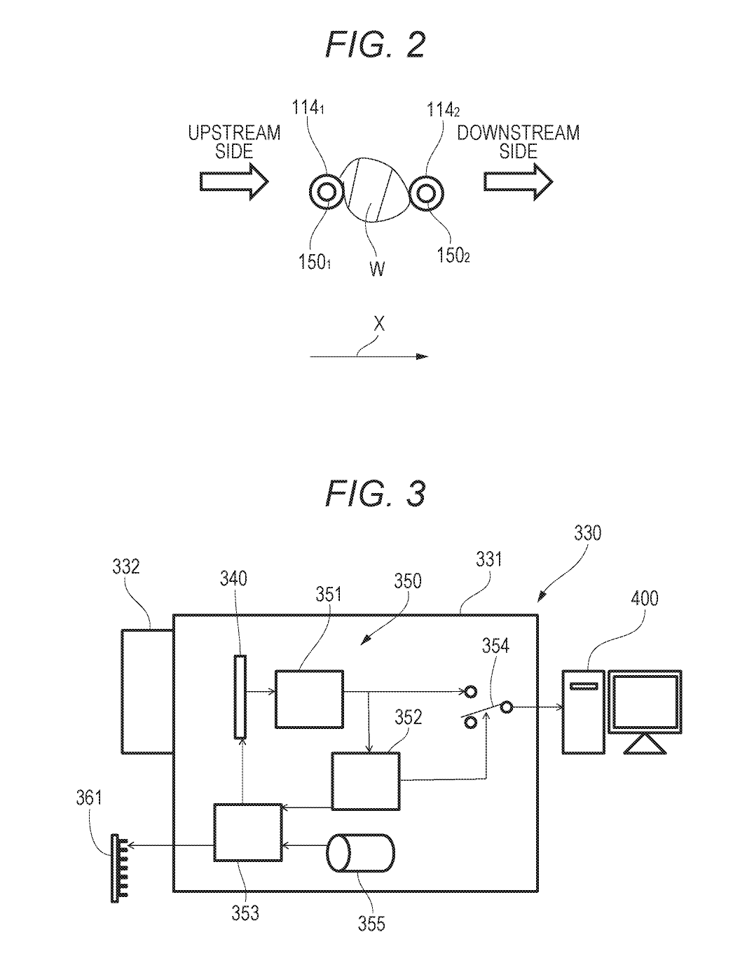

FIG. 2 is a plan view of a workpiece gripped by fingers of a robot hand viewed from a camera side, according to the first exemplary embodiment. The two mark members 150₁ and 150₂ can be seen from the image sensor 340 of the camera main body 331 through the lens 332, i.e., pass through the inside of the imaging viewing field (field angle) of the image sensor 340.

In addition, the position of the robot hand 112 is controlled so that, during the conveyance of the workpiece W, the mark members 150₁ and 150₂ become parallel to the conveyance direction X of the workpiece W. As a result, the mark member 150₂ is positioned on the conveyance destination side of the workpiece W, and the mark member 150₁ is positioned on the conveyance source side of the workpiece W.

As the mark members 150₁ and 150₂, members having large contrast from the surrounding are selected. Accordingly, the mark members 150₁ and 150₂ can be detected at high speed through the processing within the camera. The mark members 150₁ and 150₂ are formed in a circular shape in planar view. In addition, the mark member 150₁ is set to have the same size as the mark member 150₂.

In addition, the shape of the mark members 150₁ and 150₂ and the arrangement positions of the mark members 150₁ and 150₂ are not limited to those in the above description. For example, the shape of the mark members 150₁ and 150₂ may be a straight belt shape, or a cross shape. In addition, the arrangement positions are not limited to the fingers 114₁ and 114₂ as long as the mark members 150₁ and 150₂ are arranged on the upstream side and the downstream side in the conveyance direction X of the workpiece W. For example, mark members may be arranged on the palm bottom surface of the robot hand 112. In addition, mark members may be arranged on the workpiece W if possible. In addition, marks are not limited to the mark members, and may have any configuration that is identifiable as a mark. For example, a mark such as a groove or color may be applied to a robot hand itself, such as a finger and a palm bottom surface. In addition, the case is not limited to the case in which a mark is applied to a robot hand, and a case in which a mark is applied to a workpiece may be used.

FIG. 3 is a block diagram illustrating an internal configuration of a camera according to the first exemplary embodiment. The image sensor 340 includes a plurality of pixels arrayed in a matrix, and is a sensor that converts an image formed on the sensor surface through the lens 332 by exposing for a predetermined time, into an electric signal as a captured image. The image sensor 340 outputs pixel data as digital data for each pixel.

Major image sensors include a charge coupled device (CCD) image sensor and a complementary metal oxide semiconductor (CMOS) image sensor. Because the CCD image sensor includes a global shutter for simultaneously exposing all pixels, the CCD image sensor is suitable for capturing an image of a moving object. In contrast to this, the CMOS image sensor generally has a rolling shutter that outputs image data while shifting an exposure timing for each horizontal scanning. If an image of a moving object is captured using a CMOS image sensor having a rolling shutter, because an exposure timing varies in the horizontal direction, a resultant image is distorted from an actual shape. Nevertheless, some CMOS image sensors have a mechanism for temporarily saving data for each pixel, and such sensors can realize a global shutter. Thus, even if an image of a moving object is captured using such sensors, an output image is not distorted.

In the first exemplary embodiment, a moving object is handled. It is therefore, as the image sensor 340, a CCD image sensor or a CMOS image sensor equipped with a global shutter is used. As for inspection in which a change in shape does not matter, a normal CMOS image sensor can be used. In addition, as described later, for increasing a frame rate in a waiting period of a workpiece, instead of outputting all pixels, pixels in a partial region are selectively output. In other words, image capturing can be performed using only a partial pixel region.

In general, a CCD image sensor has a structure in which a pixel can be selected only in the horizontal direction. In contrast, a CMOS image sensor can freely select vertically and horizontally. Based on the foregoing, a CMOS image sensor equipped with a global shutter is the most suitable in the present exemplary embodiment.

The camera 330 includes the control unit 350 and a storage unit 355. The storage unit 355 is formed by a rewritable nonvolatile memory such as, for example, an electrically erasable programmable read only memory (EEPROM), and setting information is stored therein. The control unit 350 includes a pixel alignment circuit 351, a determination circuit 352, an imaging control circuit 353, and an external output circuit 354.

The pixel alignment circuit 351 is a circuit for aligning pixels in a pixel order according to a synchronization signal (sync signal) output from the image sensor 340, or parallelizing pixels, for transferring pixel data from the image sensor 340, to the image processing apparatus 400 on a following stage. As an alignment order, various forms are proposed by standards of transfer interfaces.

The determination circuit 352 determines whether images (mark images) of the mark members 150₁ and 150₂ are included in an image (data) captured in a selected pixel region in the image sensor 340. In addition, the determination circuit 352 generates a change in an imaging condition (pixel region to be used in image capturing), and a switching signal of the presence or absence of external output.

According to setting information read from the storage unit 355, the imaging control circuit 353 controls the image sensor 340 and the light source 361. Specifically, the imaging control circuit 353 selects a pixel region formed by a pixel group, from among the plurality of pixels of the image sensor 340, according to storage data in the storage unit 355, and controls the image sensor 340 to acquire an image from the selected pixel region. In other words, the imaging control circuit 353 controls the image sensor 340 to perform image capturing in the selected pixel region. In addition, the imaging control circuit 353 controls lighting of the light source 361.

The external output circuit 354 is a circuit for performing parallel-serial conversion of a digital signal according to the standard of an interface, and causing a state suitable for transfer by adding redundancy. In the first exemplary embodiment, the external output circuit 354 is configured to be able to select whether to output an image to the external image processing apparatus 400, according to the switching signal the input of which has been received from the determination circuit 352.

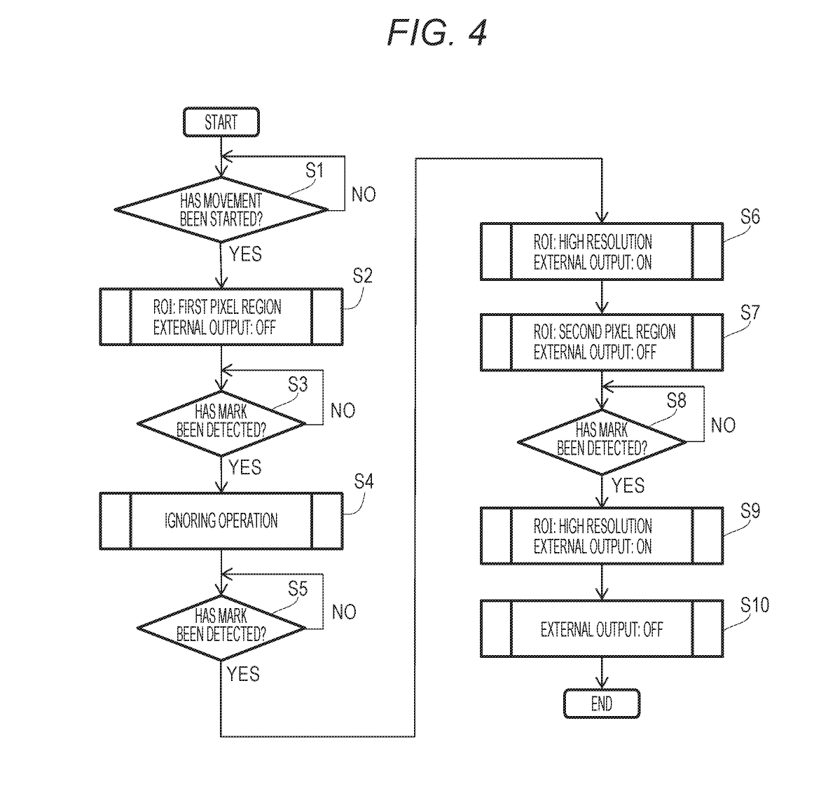

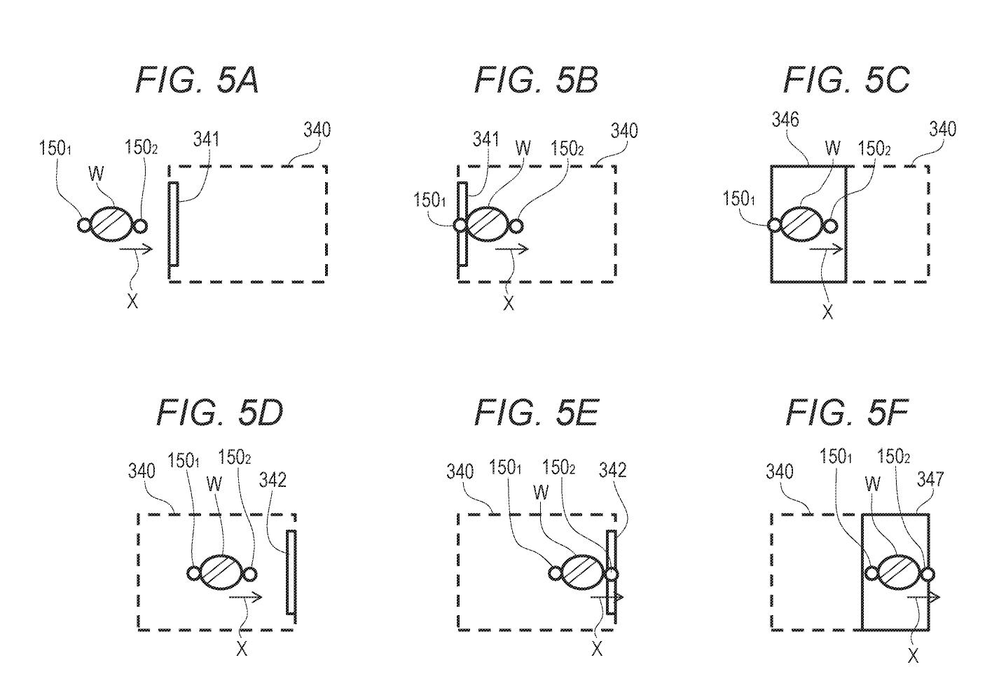

Next, a measurement method performed by the control unit 350 and the image processing apparatus 400, more specifically, an imaging method performed by the control unit 350 will be described. FIG. 4 is a flowchart illustrating an imaging method according to the first exemplary embodiment. FIGS. 5A to 5F are schematic diagrams for illustrating the imaging method according to the first exemplary embodiment.

In FIGS. 5A to 5F, a dotted-line pixel region indicates all pixels of the image sensor 340, and solid-line pixel regions indicate pixel regions 341, 342, 346, and 347 that are to be selected. Information of the pixel regions 341, 342, 346, and 347 that are to be selected by the imaging control circuit 353 is prestored in the storage unit 355. According to a signal from the robot control device 120 or the determination circuit 352, the imaging control circuit 353 refers to the storage unit 355, and selects a pixel region formed by a pixel group that is to be used in image capturing, from among the plurality of pixels of the image sensor 340.

First, the imaging control circuit 353 determines whether a start signal indicating that the movement of the workpiece W has been started has been input from the robot control device 120 (S1).

If the start signal has not been input (S1: No), that is, if the robot 110 is not conveying the workpiece W, the imaging control circuit 353 enters and stays in a standby state until the start signal is input. If the robot control device 120 outputs the start signal, the robot 110 conveys the workpiece W.

If the start signal has been input (S1: Yes), that is, while the workpiece W is being conveyed, the imaging control circuit 353 selects, from among the plurality of pixels, the first pixel region 341 positioned on the upstream side in the conveyance direction X, as illustrated in FIG. 5A. The first the pixel region 341 is a peripheral portion on the upstream side (conveyance source side) in the conveyance direction X of the image sensor 340, and is a part of the all pixels of the image sensor 340. Then, the imaging control circuit 353 causes image capturing to be performed in the first pixel region 341 (S2: first imaging processing, first imaging process). The imaging operation is performed by the first pixel region 341 at a predetermined time interval (sampling interval). The pixel alignment circuit 351 outputs, as a captured image (data), pixel data of the first pixel region 341 of the image sensor 340, that is, pixel data of only the peripheral portion on the upstream side in the conveyance direction X. As a result, sampling can be performed at high speed, and a high-speed movement of the workpiece W can be dealt with. In addition, the first pixel region 341 is to be formed by a small number of pixels. For example, the first pixel region 341 may be formed by pixels in one column in the peripheral portion on the conveyance source side of the image sensor 340. Here, in step S2, the setting of external output is set to off so that the external output circuit 354 does not output an image to the image processing apparatus 400.

Next, based on the image (data) acquired from the first pixel region 341, the determination circuit 352 first determines whether a mark image is included in the image (S3). Here, among the mark members 150₁ and 150₂, the mark member 150₂ positioned on the downstream side in the conveyance direction X enters the imaging viewing field of the first pixel region 341 earlier.

As a result of determination in step S3, if the determination circuit 352 determines that a mark image is not included (S3: No), based on an image acquired again from the first pixel region 341 at the next timing, the determination circuit 352 determines whether a mark image is included in the image. In other words, the determination circuit 352 determines whether a mark image has been detected in the first pixel region 341.

Then, as a result of determination in step S3, if the determination circuit 352 determines that a mark image is included in the image (S3: Yes), because the detected mark image is not the mark member 150₁, the determination circuit 352 performs ignoring operation processing of ignoring this (S4). Then, after the ignoring operation processing, based on an image acquired from the first pixel region 341, the determination circuit 352 determines whether a mark image is included in the image (S5). In other words, at the stage where the image of the mark member 150₂ is captured by the first pixel region 341, the workpiece W has not entered the imaging viewing field (field angle) of the image sensor 340.

As a result of determination in step S5, if the determination circuit 352 determines that a mark image is not included in the image (S5: No), based on an image acquired again from the first pixel region 341 at the next timing, the determination circuit 352 determines whether a mark image is included in the image.

When the workpiece W moves in the conveyance direction X, and the image of the mark member 150₁ on the conveyance source side is captured in the first pixel region 341 as illustrated in FIG. 5B, as a result of determination in step S5, the determination circuit 352 determines that a mark image corresponding to the mark member 150₁ is included in the image.

The above steps S3 to S5 correspond to first determination processing (first determination process) of determining whether an image of the mark member 150₁ has been captured, based on the image acquired from the first pixel region 341. In other words, in the first determination processing in steps S3 to S5, the determination circuit 352 ignores the mark image that is included for the first time in the image captured in the first pixel region 341 (S3, S4). Then, the determination circuit 352 determines, as the mark member 150₁, the mark image that is included for the second time in the image captured in the first pixel region 341 (S5).

As a result of determination in step S5, if the determination circuit 352 determines that the image of the mark member 150₁ has been captured (S5: Yes), the determination circuit 352 outputs a switching signal to the external output circuit 354 and the imaging control circuit 353. The imaging control circuit 353 receives the input of the signal from the determination circuit 352, and as illustrated in FIG. 5C, the imaging control circuit 353 selects the pixel region 346 in the image sensor 340 that has a broader area (higher resolution) than the first pixel region 341. Then, the imaging control circuit 353 causes an image of the workpiece W to be captured in the selected pixel region 346 (S6: first workpiece imaging processing, first workpiece imaging process). At this time, the imaging control circuit 353 lights the light source 361 in synchronization with the imaging timing in step S6.

Here, the pixel region 346 may correspond to all the pixels in the image sensor 340, but does not have to correspond to all the pixels as long as there is a sufficient region for a captured image including the workpiece W. In the first exemplary embodiment, during the conveyance of the workpiece W, image capturing is performed again after the image capturing of the pixel region 346. It is therefore, for preventing the workpiece W from overrunning, the minimum region is set for the captured image including the workpiece W.

In addition, the external output circuit 354 receives the input of the signal from the determination circuit 352, sets external output to on, and when the external output circuit 354 receives the input of data of a captured image (first captured image) from the pixel region 346, outputs the data of the captured image to the image processing apparatus 400.

Here, the determination operation performed by the determination circuit 352 will be described in detail. A luminance threshold corresponding to luminance between the brightness of a mark image and the brightness of a background, and a pixel threshold corresponding to the number of pixels selected in a case in which a mark image is included in captured image data are prestored in the storage unit 355.

The determination circuit 352 performs binarization processing on the acquired image data, and counts the number of bright pixel data (pixels) (the number of pixels) having luminance equal to or larger than the luminance threshold, among pixel data (pixels) of image data having been subjected to the binarization processing. Next, the determination circuit 352 determines whether the number of pixels obtained by the counting is equal to or larger than the pixel threshold, that is, whether the number of pixels has reached the pixel threshold. If the number of pixels has reached the pixel threshold, the mark image is included in the image captured by the pixel region 341. In this manner, the determination circuit 352 determines whether the mark image is included in the image captured in the first pixel region 341, based on the luminance of pixel data in the image captured in the first pixel region 341.

Here, in the first exemplary embodiment, because the sizes of the mark member 150₁ and the mark member 150₂ are the same, it is difficult to determine a mark member of which a mark image has been detected, only based on the counted number of pixels.

In addition, among the mark images detected in the first pixel region 341 during the conveyance of the workpiece W, the mark image detected for the first time is the mark member 150₂, and the mark image subsequently detected for the second time is the mark member 150₁. Then, until the mark member 150₂ goes out of the imaging viewing field of the first pixel region 341, the counted number of pixels does not fall below the pixel threshold, and if the mark member 150₂ goes out of the imaging viewing field of the first pixel region 341 (or in the middle of going out of the imaging viewing field of the first pixel region 341), the number of pixels falls below the pixel threshold. Specifically, the counted number becomes the minimum value (e.g., 0). Then, if the counted number reaches the pixel threshold again, the next mark member 150₁ has entered the imaging viewing field of the first pixel region 341.

Thus, in the first exemplary embodiment, the determination circuit 352 counts the number of pixels with pixel data having luminance being equal to or larger than the luminance threshold, in the image data acquired from the first pixel region 341. If the counted number of pixels becomes equal to or larger than the pixel threshold for the first time, the mark image that is included for the first time has been detected. Thus, the workpiece W has not moved into the field angle yet, and the determination circuit 352 performs ignoring operation processing of ignoring until the counted number of pixels becomes equal to or smaller than a lower limit threshold.

Thus, during the ignoring operation processing, the determination circuit 352 does not output a switching signal to the imaging control circuit 353 and the external output circuit 354. Here, the lower limit threshold is prestored in the storage unit 355 as setting information. The lower limit threshold is a value smaller than the pixel threshold, and may be set to the minimum value (e.g., 0).

If the counted number of pixels becomes equal to or larger than the pixel threshold again, because the mark image that is included for the second time has been detected, the determination circuit 352 determines that an image of the mark member 150₂ has been captured.

In this manner, in the first exemplary embodiment, even if the counted number of pixels reaches the pixel threshold for the first time, the determination operation is continued until the mark member 150₂ goes out of the imaging viewing field of the first pixel region 341, and the next mark member 150₁ enters the imaging viewing field of the first pixel region 341.

After that, when the mark image has been detected for the second time, an imaging timing at which a captured image for the first external output is to be obtained comes for the first time. The determination circuit 352 therefore outputs a switching signal to the imaging control circuit 353 and the external output circuit 354.

In step S6, the imaging control circuit 353 that has received the switching signal switches an image acquisition range to a range in which the entire workpiece W falls within the imaging viewing field, that is, the pixel region 346 having a broad area (high resolution), as illustrated in FIG. 5C, and performs image capturing of the workpiece W in synchronization with the light emission of the light source 361. In addition, the external output circuit 354 that has received the switching signal sets external output to on, and outputs the first captured image to the image processing apparatus 400.

In this manner, it is detected that the workpiece W has reached the peripheral portion on the conveyance source side of the imaging viewing field of the image sensor 340, using the first pixel region 341, and the first pixel region 341 is instantaneously switched to the pixel region 346, in which image capturing of the workpiece W is performed.

After the image capturing of the first image is ended, that is, during the conveyance of the workpiece W after the image capturing, the imaging control circuit 353 promptly selects, from among the plurality of pixels, the second pixel region 342 positioned on the downstream side in the conveyance direction X, as illustrated in FIG. 5D. The second pixel region 342 is a peripheral portion on the downstream side (conveyance destination side) in the conveyance direction X of the image sensor 340, and is a part of the all pixels of the image sensor 340. Then, the imaging control circuit 353 causes image capturing to be performed in the second pixel region 342 (S7: second imaging processing, second imaging process). The imaging operation is performed in the second pixel region 342 at a predetermined time interval (sampling interval). The pixel alignment circuit 351 outputs, as captured image data, pixel data of the second pixel region 342 of the image sensor 340, that is, pixel data of only the peripheral portion on the downstream side in the conveyance direction X. As a result, sampling can be performed at high speed, and a high-speed movement of the workpiece W can be dealt with. In addition, the second pixel region 342 is to be formed by a small number of pixels. For example, the second pixel region 342 may be formed by pixels in one column in the peripheral portion on the conveyance destination side of the image sensor 340. Here, in step S7, after the first image output, the imaging control circuit 353 sets the setting of external output of the external output circuit 354 to off so as not to output image data to the image processing apparatus 400.

Next, based on the image acquired from the second pixel region 342, the determination circuit 352 determines whether an image of the mark member 150₂ has been captured (i.e., the mark member 150₂ has been detected) (S8: second determination processing, second determination process). Here, among the mark members 150₁ and 150₂, the mark member 150₂ positioned on the downstream side in the conveyance direction X enters the imaging viewing field of the second pixel region 342 earlier. In other words, at a time point at which the mark member 150₂ is detected, the workpiece W reaches the peripheral portion of the imaging viewing field of the image sensor 340. Thus, in step S8, the determination circuit 352 determines whether the mark image has been detected for the first time since the image capturing has been started in the second pixel region 342.

As a result of determination in step S8, if the determination circuit 352 determines that an image of the mark member 150₂ has not been captured (S8: No), the determination circuit 352 determines whether an image of the mark member 150₂ has been captured, based on an image acquired from the second pixel region 342 again at the next timing.

Then, as a result of determination in step S8, if the determination circuit 352 determines that an image of the mark member 150₂ has been captured (S8: Yes), that is, when a state illustrated in FIG. 5E is caused, the determination circuit 352 outputs a switching signal to the external output circuit 354 and the imaging control circuit 353. The imaging control circuit 353 receives the input of the signal from the determination circuit 352, and selects the pixel region 347 in the image sensor 340 that has a broader area (higher resolution) than the second pixel region 342, as illustrated in FIG. 5F. Then, the imaging control circuit 353 causes an image of the workpiece W to be captured in the selected pixel region 347 (S9: second workpiece imaging processing, second workpiece imaging process). At this time, the imaging control circuit 353 lights the light source 361 in synchronization with the imaging timing in step S9.

Here, the pixel region 347 may correspond to all the pixels in the image sensor 340, but does not have to correspond to all the pixels as long as there is a sufficient region for a captured image including the workpiece W.

In addition, the external output circuit 354 receives the input of the signal from the determination circuit 352, sets external output to on, and when the external output circuit 354 receives the input of data of a captured image (second captured image) from the pixel region 347, outputs the data of the captured image to the image processing apparatus 400.

In this manner, by the conveyance of the workpiece W, the mark member 150₂ enters the imaging viewing field of the second pixel region 342 precedential to the mark member 150₁. Thus, in the first exemplary embodiment, the determination circuit 352 counts the number of pixels with pixel data having luminance being equal to or larger than the luminance threshold, in the image acquired from the second pixel region 342. Then, if the counted number of pixels becomes equal to or larger than the pixel threshold for the first time, because an image of the mark member 150₂ has been captured, the determination circuit 352 outputs a switching signal to the imaging control circuit 353 and the external output circuit 354.

In step S9, the imaging control circuit 353 that has received the switching signal switches an image acquisition range to a range in which the entire workpiece W falls within the imaging viewing field, that is, the pixel region 347 having a broad area (high resolution), as illustrated in FIG. 5F, and performs image capturing of the workpiece W in synchronization with the light emission of the light source 361. In addition, the external output circuit 354 that has received the switching signal sets external output to on, and outputs the second captured image to the image processing apparatus 400.

In this manner, it is detected that the workpiece W has reached the peripheral portion on the conveyance destination side of the imaging viewing field of the image sensor 340, using the second pixel region 342, and the second pixel region 342 is instantaneously switched to the pixel region 347, in which image capturing of the workpiece W is performed.

After that, the external output circuit 354 sets external output to off (S10), and ends the processing. The image processing apparatus 400 that has acquired the two captured images three-dimensionally measures the workpiece W based on the two captured images obtained by the above-described imaging method.

As described above, without controlling an imaging timing (switching of pixel region) by the robot control device 120 and the image processing apparatus 400, two captured images having large (almost the largest) disparity can be automatically acquired through the processing of the control unit 350 in the camera 330. In this manner, with a simple configuration, two captured images suitable for the monocular stereoscopic method can be obtained without stopping the conveyance of the workpiece. Thus, in the image processing apparatus 400, highly-accurate three-dimensional measurement of the workpiece W is enabled by the monocular stereoscopic method.

In addition, the control unit 350 does not have to communicate with an external controller such as the image processing apparatus 400 and the robot control device 120, for capturing an image of the workpiece W being conveyed, at different imaging timings. Thus, a communication time is reduced, and high-speed movement of the workpiece W can be dealt with.

Through the above operation, two captured images having the almost-largest mutual difference in image capturing position that are suitable for the monocular stereoscopic method can be obtained. In the monocular stereoscopic method, this difference corresponds to a base length, and as the base length becomes longer, digital resolution in a depth direction increases. Thus, measurement can be performed more accurately.

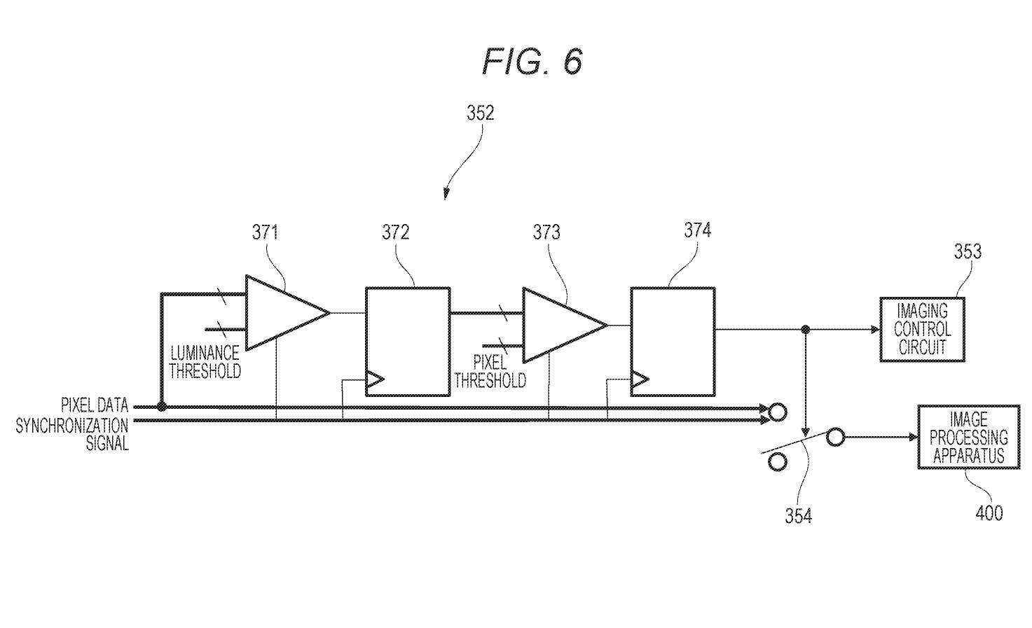

Here, in the first exemplary embodiment, because the determination circuit 352 performs high-speed processing in synchronization with the streaming of a pixel signal, the determination circuit 352 is formed by a logic circuit (hardware). FIG. 6 is a circuit diagram illustrating a determination circuit according to the first exemplary embodiment. The determination circuit 352 includes comparators 371 and 373, and counters 372 and 374. The comparator 371 determines whether the luminance of input pixel data is equal to or larger than a preset luminance threshold. The counter 372 counts the number of pixels having luminance being equal to or larger the luminance threshold. The comparator 373 determines whether the number of pixels counted by the counter 372 is equal to or larger than the pixel threshold. The counter 374 is a counter for performing the above-described ignoring operation processing.

The comparators 371 and 373 and the counters 372 and 374 are set and reset according to a synchronization signal synchronized with pixel data and an image frame that have been output from the image sensor 340. Thus, determination can be performed instantaneously and more efficiently as compared with processing performed by software.

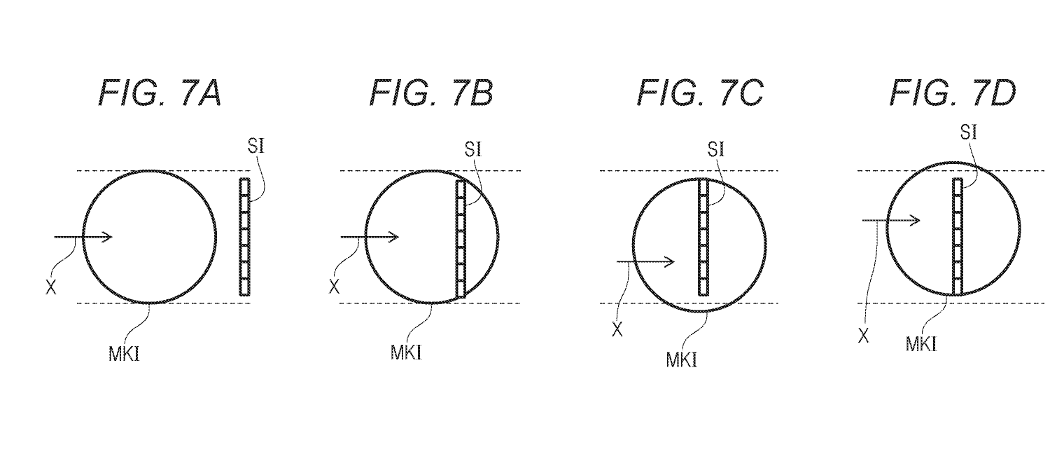

FIGS. 7A to 7D are schematic diagrams each illustrating a mark image on an image, and a pixel image-captured by a selected pixel region. As illustrated in FIG. 7A, a mark image MKI obtained by capturing an image of the mark member 150₁ or 150₂ has a circular shape, and a region SI obtained by performing image capturing by the pixel region 341 or 342 is pixel data of one column.

The mark members 150₁ and 150₂ and the pixel regions 341 and 342 are set so that a diameter of the mark image MKI becomes longer than a length of the region SI on the image. In this case, the pixel threshold is set to a value at which all the pixels become bright pixels, that is, set to the same value as the number of pixels in one column of the pixel region 341 or 342. Thus, if luminance becomes equal to or larger than the luminance threshold in all pixel data of images captured by the pixel regions 341 and 342, it is determined that a mark image is included.

FIG. 7B illustrates an image that first satisfies a determination condition in a case in which a mark member passes through a supposed reference position. FIGS. 7C and 7D illustrate images that first satisfy the determination condition in a case in which the trajectory of the mark member slightly deviates from the supposed reference position downward and upward, respectively. In this manner, if the mark members 150₁ and 150₂ have a slight deviation amount with respect to a target trajectory, a mark can be detected. In addition, if the mark member deviates more than the deviation in FIG. 7C or 7D, the mark is not detected, and image capturing of the workpiece W fails. By setting the mark members 150₁ and 150₂ and the pixel regions 341 and 342 in this manner, positional accuracy of the workpiece W in capturing an image of the workpiece W can be limited to the inside of an allowable range. Thus, the accuracy of three-dimensional measurement that is based on two captured images can be enhanced. In addition, even if the trajectory of a mark member deviates upward and downward, by an amount corresponding to the mark diameter and the number of pixels in a selected range, or the mark member enters the imaging viewing field in a diagonal direction, an image of a workpiece can be captured as long as the deviation is within the allowable range. In this manner, an image capturing error during the movement that is caused by a variation factor of the robot 110 that conveys the workpiece W can be prevented.

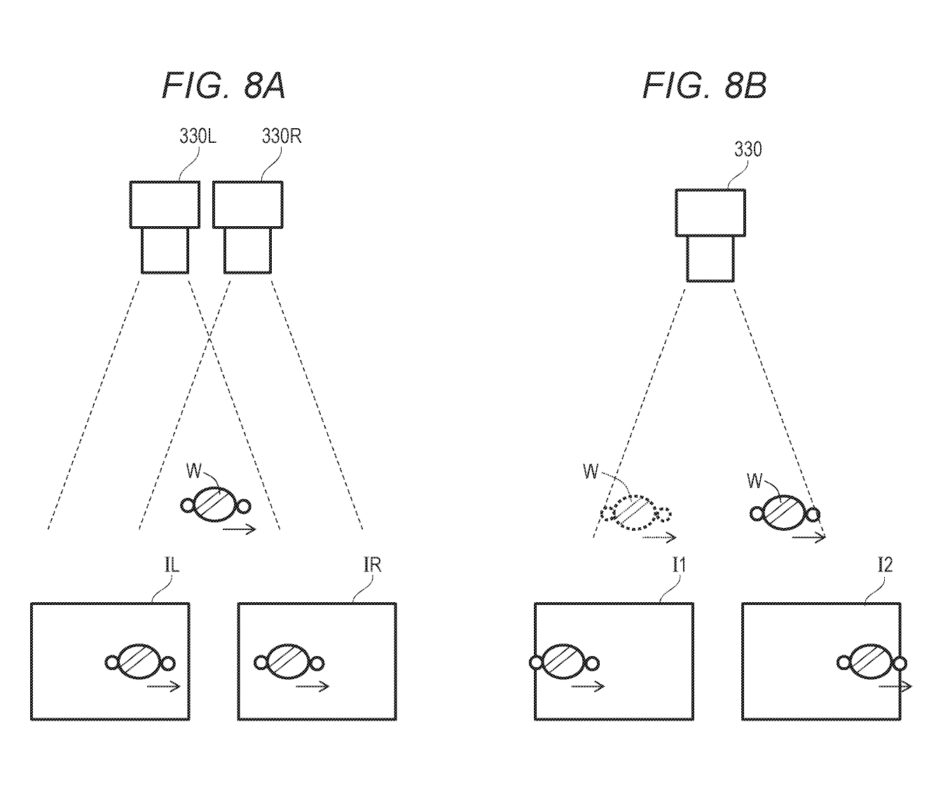

Here, the principle of the monocular stereoscopic method executed by the image processing apparatus 400 will be described. FIG. 8A is a principle diagram illustrating a three-dimensional measurement method using stereoscopic cameras. FIG. 8B is a principle diagram illustrating a three-dimensional measurement method using a monocular stereoscopic method.

In the stereoscopic method using the stereoscopic cameras, using two cameras 330R and 330L, three-dimensional measurement is performed based on two captured images IR and IL, by utilizing the disparity generated when images of the workpiece W remaining still are captured at the same imaging timing. On the other hand, in the monocular stereoscopic method, using the single camera 330, two captured images I1 and I2 having disparity are acquired by moving the workpiece W, and three-dimensional measurement is performed.

A focal length of the lens of the camera 330 is denoted by f, an imaging magnification on a surface serving as a reference (reference surface) that has been set to the palm bottom surface of the robot hand or the like is denoted by A, a movement amount of the workpiece W between the two captured images I1 and I2 is denoted by B, and disparity between measurement points on the images I1 and I2 is denoted by δ. A position Z in a light axis direction of a measurement point from the reference surface is represented by Z=A×δ×f/B. In other words, in the monocular stereoscopic method, the resolution of one pixel of disparity is inversely proportional to (fine) the movement amount of the workpiece W.

According to the first exemplary embodiment, a difference between two positions of the workpiece W in image capturing can be made almost the largest. Thus, three-dimensional measurement using the monocular stereoscopic method can be accurately performed. In addition, because image capturing for performing the three-dimensional measurement and the position detection of a mark are performed by the same image sensor 340, as compared with a method of using a position detector, position adjustment and timing adjustment become unnecessary. During the standby time of a mark member, because only a very small number of pixel data are acquired by the pixel regions 341 and 342, high-speed sampling can be performed. For example, for an image sensor having one million pixels, the pixel regions 341 and 342 can be made to have about 30 pixels. Because complicated processing is not required for determination processing, high-speed sampling at several tens [kHz] can be empirically realized. As a result, it becomes unnecessary to once stop the workpiece W, and the workpiece W can be moved at high speed. This can enhance throughput.

In addition, according to the first exemplary embodiment, the control unit 350 of the camera 330 can automatically determine an imaging timing at which an image of the workpiece is to be captured, based on the detection result of the image sensor 340, without sequentially acquiring position information of the workpiece W from the robot control device 120.

In addition, according to the first exemplary embodiment, the mark members 150₁ and 150₂ are applied to the fingers 114₁ and 114₂. Thus, if the robot hand 112 grips the workpiece W, the mark members 150₁ and 150₂ move together with the fingers according to the size of the workpiece W. The mark members 150₁ and 150₂ are thereby adjusted to come close to end portions on the upstream and downstream sides of the workpiece W. Thus, even in the case of capturing an image of the workpiece W having a different size, an image of the workpiece W can be accurately captured in the vicinity of both end portions on the conveyance direction upstream and downstream sides of the imaging viewing field of the image sensor 340. Thus, with a simple configuration, the accuracy of three-dimensional measurement can be enhanced for workpieces W having various sizes.

### Second Exemplary Embodiment

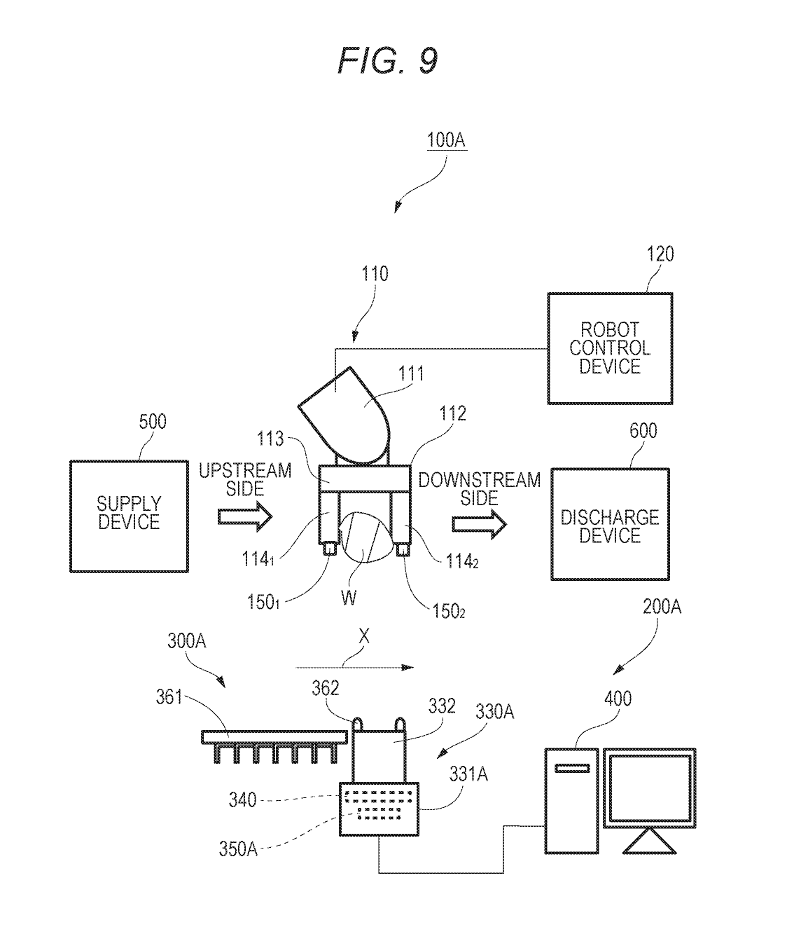

Next, a production system according to a second exemplary embodiment of the disclosure will be described. FIG. 9 is a schematic diagram illustrating a schematic configuration of a production system according to the second exemplary embodiment. In FIG. 9, configurations similar to those in FIG. 1 are assigned the same signs.

A production system 100A according to the second exemplary embodiment includes a measurement system 200A, the robot 110 serving as a conveyance device for conveying a workpiece W, the robot control device 120, the supply device 500 being an upstream side device, and the discharge device 600 being a downstream side device.

The mark members 150₁ and 150₂ being marks are applied to the fingers 114₁ and 114₂ of the robot hand 112. Each of the mark members 150₁ and 150₂ is a member having a retroreflective property (i.e., retroreflective member).

The measurement system 200A includes an imaging system 300A and the image processing apparatus 400. The imaging system 300A includes a camera 330A being a monocular imaging apparatus, the light source 361 being a large light source, and a light source 362 being a small light source.

The camera 330A is a digital camera for automatically capturing an image of the workpiece W serving as an inspection measurement target. The camera 330A has a camera main body 331A serving as an imaging unit, and the lens 332 attached to the camera main body 331A. The camera main body 331A has the image sensor 340, and a control unit 350A for controlling the image sensor 340. The camera 330A is installed while being fixed on a stand (not illustrated) or the like. The light source 361 serving as an illumination device is, for example, a flash device (stroboscope) for emitting flashlight, and emits light onto the workpiece W when an image of the workpiece W is captured.

The light source 362 emits light onto the mark members 150₁ and 150₂, and is arranged in the vicinity of the lens 332. As compared with the light source 361, the illuminance of the light source 362 is set to be lower and a light emission unit area is set to be narrower. If a mirror surface or a surface having high reflectance exists on the workpiece, even if the illuminance is set to be low, regular reflection light directly enters the camera from the light source, and this cannot be distinguished from light caused by retroreflection, which will be described later. Nevertheless, if the light emission unit area is set to be narrow, this can be easily distinguished from the reflection from the retroreflective member that is to be described later, based on a difference in an area of a bright region.

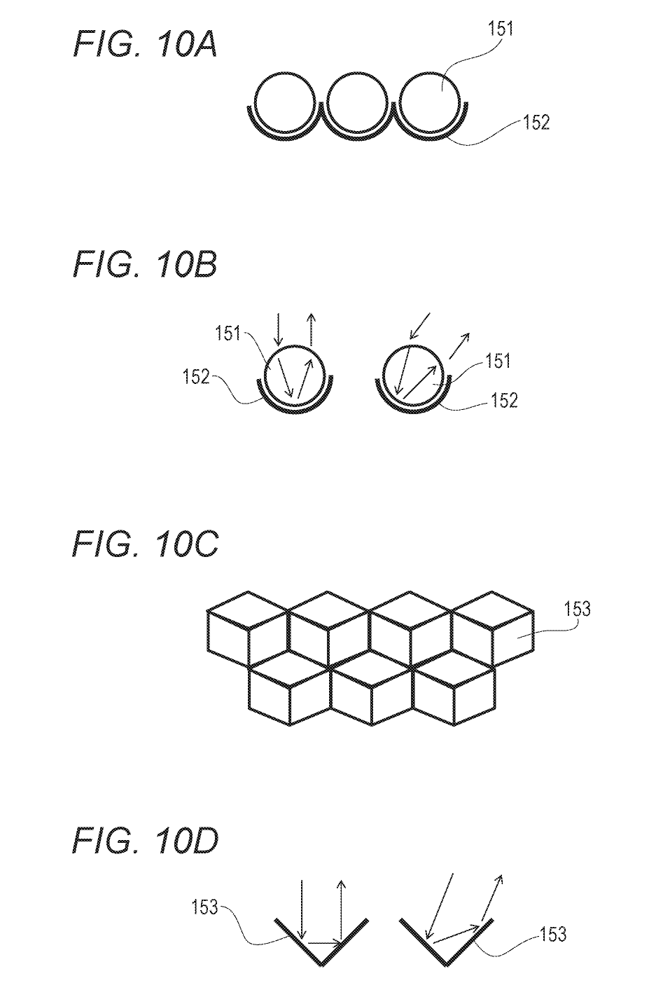

FIGS. 10A to 10D are explanatory diagrams illustrating examples and principle of retroreflective members. As an example of a retroreflective member, as illustrated in FIG. 10A, there is a method of using a highly refractive member 151 such as glass called microbeads, and a reflective member 152 installed on the bottom surface. As illustrated in FIG. 10B, light that has entered the highly refractive member 151 is reflected to an original incident direction by two refractions by the highly refractive member 151. In this manner, a phenomenon in which light that has entered from any direction is reflected to the original direction is called retroreflection. By making the size of high refractive index members (beads) 151 small, and tightly spreading the members over, such reflection can be regarded as reflecting on the entire surface, from a macroscopic viewpoint.

In addition, as another example of a retroreflective member, as illustrated in FIG. 10C, there is a method of using corner cubes formed by flat mirrors 153 forming a predetermined angle with respect to each other, and being combined so as to form a protruding shape. As illustrated in FIG. 10D, this case also shows such a retroreflective property that incident light is reflected to the original direction by being reflected on the flat mirrors 153 several times. In addition, retroreflective members are not limited to these examples, and any retroreflective member may be used.

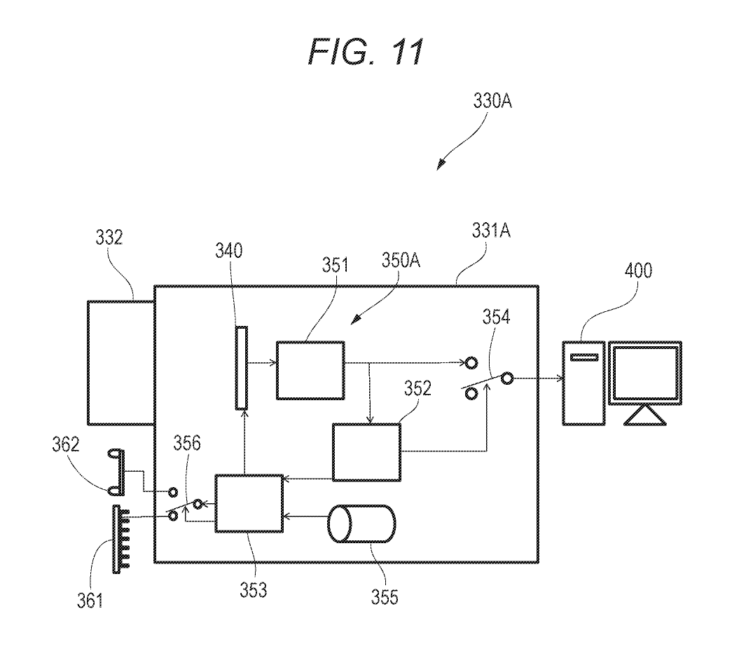

FIG. 11 is a block diagram illustrating an internal configuration of a camera according to the second exemplary embodiment. The camera 330A includes the control unit 350A and the storage unit 355. The control unit 350A includes the pixel alignment circuit 351, the determination circuit 352, the imaging control circuit 353, the external output circuit 354, and a switching circuit 356. By the control of the imaging control circuit 353, the switching circuit 356 exclusively switches the light sources 361 and 362 to light up, and causes the light source 361 or the light source 362 to emit light, according to a synchronization signal from the imaging control circuit 353.

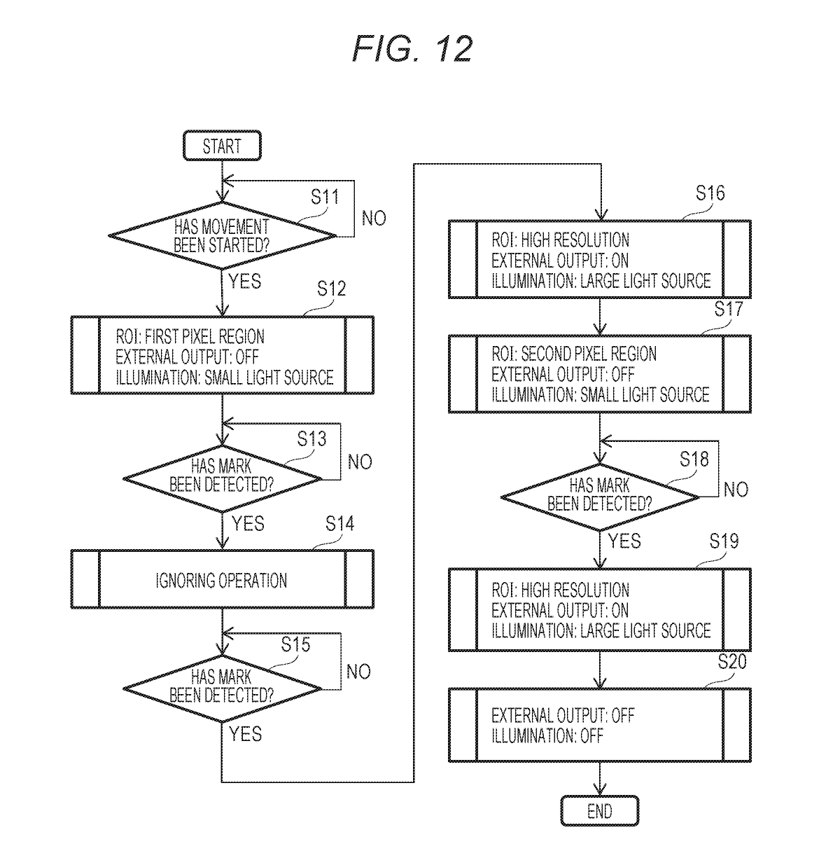

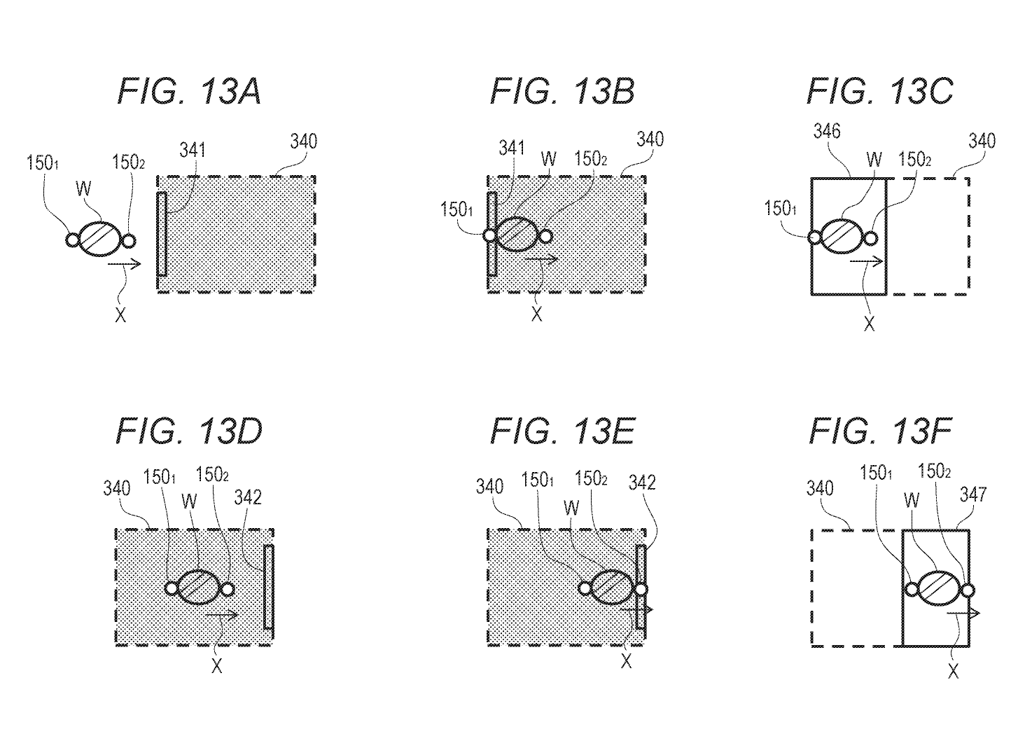

Next, a measurement method performed by the control unit 350A and the image processing apparatus 400, more specifically, an imaging method performed by the control unit 350A will be described. FIG. 12 is a flowchart illustrating an imaging method according to the second exemplary embodiment. FIGS. 13A to 13F are schematic diagrams for illustrating the imaging method according to the second exemplary embodiment.

First, the imaging control circuit 353 determines whether a start signal indicating that the movement of the workpiece W has been started has been input from the robot control device 120 (S11).

If the start signal has not been input (S11: No), that is, if the robot 110 is not conveying the workpiece W, the imaging control circuit 353 enters and stays in a standby state until the start signal is input. If the robot control device 120 outputs the start signal, the robot 110 conveys the workpiece W.

If the start signal has been input (S11: Yes), that is, while the workpiece W is being conveyed, the imaging control circuit 353 selects, from among the plurality of pixels, the first pixel region 341 positioned on the upstream side in the conveyance direction X, as illustrated in FIG. 13A. Then, the imaging control circuit 353 causes image capturing to be performed in the first pixel region 341 (S12: first imaging processing, first imaging process). The imaging operation is performed by the first pixel region 341 at a predetermined time interval (sampling interval). The pixel alignment circuit 351 outputs, as captured image data, pixel data of the first pixel region 341 of the image sensor 340, that is, pixel data of only the peripheral portion on the upstream side in the conveyance direction X. As a result, sampling can be performed at high speed, and a high-speed movement of the workpiece W can be dealt with. In addition, the first pixel region 341 is to be formed by a small number of pixels. For example, the first pixel region 341 may be formed by pixels in one column in the peripheral portion on the conveyance source side of the image sensor 340. Here, in step S12, the setting of external output is set to off so that the external output circuit 354 does not output image data to the image processing apparatus 400. In addition, the switching circuit 356 has been switched by the imaging control circuit 353 to the light source 362, and the light source 362 is controlled to light up during the image capturing. Because the light source 362 has small illuminance, and cannot illuminate the workpiece W and a structural object and the like of the robot hand 112 sufficiently, at the time point in FIG. 13A, it is almost dark throughout the inside of the field angle.

Next, based on the image acquired from the first pixel region 341, the determination circuit 352 first determines whether a mark image is included in the image (S13). As a result of determination in step S13, if the determination circuit 352 determines that a mark image is not included (S13: No), based on an image acquired again from the first pixel region 341 at the next timing, the determination circuit 352 determines whether a mark image is included in the image. In other words, the determination circuit 352 determines whether a mark image has been detected in the first pixel region 341.

Then, as a result of determination in step S13, if the determination circuit 352 determines that a mark image is included in the image (S13: Yes), because the detected mark image is not the mark member 150₁, the determination circuit 352 performs ignoring operation processing of ignoring this (S14). Then, after the ignoring operation processing, based on an image acquired from the first pixel region 341, the determination circuit 352 determines whether a mark image is included in an image (S15). In other words, at the stage where an image of the mark member 150₂ is captured by the first pixel region 341, the workpiece W has not entered the imaging viewing field (field angle) of the image sensor 340.

As a result of determination in step S15, if the determination circuit 352 determines that a mark image is not included in the image (S15: No), based on an image acquired again from the first pixel region 341 at the next timing, the determination circuit 352 determines whether a mark image is included in the image.

When the workpiece W moves in the conveyance direction X, and an image of the mark member 150₁ on the conveyance source side is captured in the first pixel region 341 as illustrated in FIG. 13B, as a result of determination in step S15, the determination circuit 352 determines that a mark image corresponding to the mark member 150₁ is included in the image.

The above steps S13 to S15 correspond to first determination processing (first determination process) of determining whether an image of the mark member 150₁ has been captured, based on the image acquired from the first pixel region 341. In other words, in the first determination processing in steps S13 to S15, the determination circuit 352 ignores the mark image that is included for the first time in the image captured in the first pixel region 341 (S13, S14). Then, the determination circuit 352 determines, as the mark member 150₁, the mark image that is included for the second time in the image captured in the first pixel region 341 (S15).

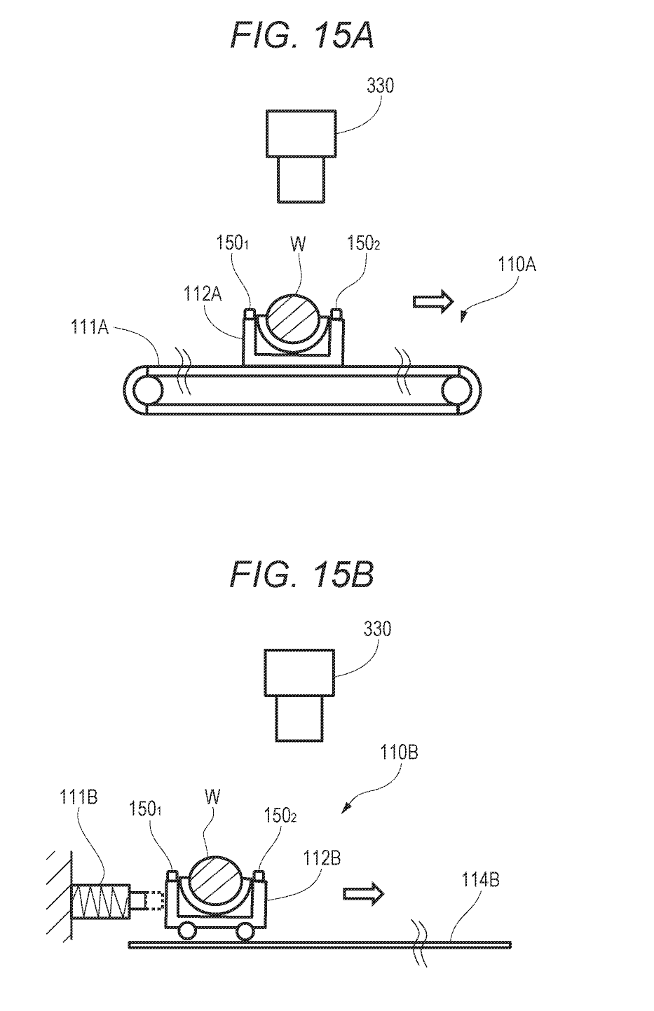

As a result of determination in step S15, if the determination circuit 352 determines that an image of the mark member 150₁ has been captured (S15: Yes), the determination circuit 352 outputs a switching signal to the external output circuit 354 and the imaging control circuit 353. The imaging control circuit 353 receives the input of the signal from the determination circuit 352, and as illustrated in FIG. 15C, the imaging control circuit 353 selects the pixel region 346 in the image sensor 340 that has a broader area (higher resolution) than the first pixel region 341. Then, the imaging control circuit 353 causes an image of the workpiece W to be captured in the selected pixel region 346 (S16: first workpiece imaging processing, first workpiece imaging process). At this time, the imaging control circuit 353 controls the switching circuit 356 so as to light the light source 361 in synchronization with the imaging timing in step S16.

In addition, if a moving speed of the workpiece W is fast, short shutter speed is used in the camera 330A, and for obtaining an image having brightness that enables image processing in the image processing apparatus 400, the illuminance of the light source 361 is to be made stronger. If the illuminance is simply made stronger, surrounding image processing apparatuses are affected. Nevertheless, if the light source 361 is caused to emit light in synchronization with a shutter, because a light emission time is very short time, mutual interference between the image processing apparatuses can be prevented. The same applies to the case of capturing an image to be output to the image processing apparatus 400 for the second time, which will be described later.

Here, the pixel region 346 may correspond to all the pixels in the image sensor 340, but does not have to correspond to all the pixels as long as there is a sufficient region for a captured image including the workpiece W. In the second exemplary embodiment, during the conveyance of the workpiece W, image capturing is performed again after the image capturing of the pixel region 346. It is therefore, for preventing the workpiece W from overrunning, the minimum region is set for the captured image including the workpiece W.

In addition, the external output circuit 354 receives the input of the signal from the determination circuit 352, sets external output to on, and when the external output circuit 354 receives the input of data of a captured image (first captured image) from the pixel region 346, outputs the data of the captured image to the image processing apparatus 400.

After the image capturing of the first image is ended, that is, during the conveyance of the workpiece W after the image capturing, the imaging control circuit 353 promptly selects, from among the plurality of pixels, the second pixel region 342 positioned on the downstream side in the conveyance direction X, as illustrated in FIG. 13D. The second pixel region 342 is a peripheral portion on the downstream side (conveyance destination side) in the conveyance direction X of the image sensor 340. Then, the imaging control circuit 353 causes image capturing to be performed in the second pixel region 342 (S17: second imaging processing, second imaging process). The imaging operation is performed by the second pixel region 342 at a predetermined time interval (sampling interval). The pixel alignment circuit 351 outputs, as captured image data, pixel data of the second pixel region 342 of the image sensor 340, that is, pixel data of only the peripheral portion on the downstream side in the conveyance direction X. As a result, sampling can be performed at high speed, and a high-speed movement of the workpiece W can be dealt with. In addition, the second pixel region 342 is to be formed by a small number of pixels. For example, the second pixel region 342 may be formed by pixels in one column in the peripheral portion on the conveyance destination side of the image sensor 340. Here, in step S17, after the first image output, the imaging control circuit 353 sets the setting of external output of the external output circuit 354 to off so as not to output image data to the image processing apparatus 400. In addition, the switching circuit 356 has been switched by the imaging control circuit 353 to the light source 362, and the light source 362 is controlled to light up during the image capturing.

Next, based on the image acquired from the second pixel region 342, the determination circuit 352 determines whether an image of the mark member 150₂ has been captured (i.e., the mark member 150₂ has been detected) (S18: second determination processing, second determination process). Here, among the mark members 150₁ and 150₂, the mark member 150₂ positioned on the downstream side in the conveyance direction X enters the imaging viewing field of the second pixel region 342 earlier. In other words, at a time point at which the mark member 150₂ is detected, the workpiece W reaches the peripheral portion of the imaging viewing field of the image sensor 340. In other words, at a time point at which the mark member 150₂ is detected, the workpiece W reaches the peripheral portion on the imaging viewing field of the image sensor 340. Thus, in step S18, the determination circuit 352 determines whether the mark image has been detected for the first time since the image capturing has been started in the second pixel region 342.

As a result of determination in step S18, if the determination circuit 352 determines that an image of the mark member 150₂ has not been captured (S18: No), based on an image acquired from the second pixel region 342 again at the next timing, the determination circuit 352 determines whether an image of the mark member 150₂ has been captured.

Then, as a result of determination in step S18, if the determination circuit 352 determines that an image of the mark member 150₂ has been captured (S18: Yes), that is, when a state illustrated in FIG. 13E is caused, the determination circuit 352 outputs a switching signal to the external output circuit 354 and the imaging control circuit 353. The imaging control circuit 353 receives the input of the signal from the determination circuit 352, and as illustrated in FIG. 13F, selects the pixel region 347 in the image sensor 340 that has a broader area (higher resolution) than the second pixel region 342. Then, the imaging control circuit 353 causes an image of the workpiece W to be captured in the selected pixel region 347 (S19: second workpiece imaging processing, second workpiece imaging process). At this time, the imaging control circuit 353 controls the switching circuit 356 so as to light the light source 361 in synchronization with the imaging timing in step S19.

Here, the pixel region 347 may correspond to all the pixels in the image sensor 340, but does not have to correspond to all the pixels as long as there is a sufficient region for a captured image including the workpiece W.

In addition, the external output circuit 354 receives the input of the signal from the determination circuit 352, sets external output to on, and when the external output circuit 354 receives the input of data of a captured image (second captured image) from the pixel region 347, outputs the data of the second captured image to the image processing apparatus 400.

In this manner, it is detected that the workpiece W has reached the peripheral portion on the conveyance destination side of the imaging viewing field of the image sensor 340, using the second pixel region 342, and the second pixel region 342 is instantaneously switched to the pixel region 347, in which image capturing of the workpiece W is performed.

After that, the external output circuit 354 sets external output to off, and the switching circuit 356 turns off all the light sources 361 and 362 (S20), and the processing ends. Based on the two captured images obtained from the above-described imaging method, the image processing apparatus 400 that has acquired the two captured images three-dimensionally measures the workpiece W through calculation processing similar to that in the first exemplary embodiment.

In the second exemplary embodiment, if the mark members 150₁ and 150₂ having the retroreflective property enter the imaging viewing field, as illustrated in FIGS. 13B, 13D, and 13E, the mark members 150₁ and 150₂ having the retroreflective property are included in the image as images brighter than the surrounding.

The light source 362 is arranged in the vicinity of the lens 332 of the camera 330. Thus, retroreflection light from the mark members 150₁ and 150₂ is efficiently reflected in the installation direction of the light source 362, that is, to the direction of the lens 332. With this configuration, as only for the mark members 150₁ and 150₂ being retroreflective members, wherever in the imaging viewing field the mark members 150₁ and 150₂ exist, bright mark images are included in the image. In addition, the brightness of the background becomes almost zero. Thus, high contrast can be obtained between the background and the mark images.

Thus, as for a mark determination algorithm in the camera, a mark can be detected by a simple algorithm such as static binarization and the determination of the number of bright pixels. The above algorithm is suitable for hardware logic implementation, and the determination circuit 352 can be formed by a logic circuit as illustrated in FIG. 6 that has been described in the first exemplary embodiment. Thus, because the determination circuit 352 can be implemented without disturbing the streaming of image output from the image sensor 340, in addition to a small number of pixels to be selected, a mark can be detected at further higher speed, and stably.

Through the above operation, two captured images having almost the largest disparity that are suitable for the monocular stereoscopic method can be stably obtained without stopping the conveyance of the workpiece. In the monocular stereoscopic method, this difference corresponds to a base length, and as the base length becomes longer, digital resolution in a depth direction increases. Thus, measurement can be performed more accurately. Particularly in the second exemplary embodiment, because the contrast of the mark is high, and the accuracy of detection and high-speed property is extremely high. The accuracy of three-dimensional measurement of the workpiece is therefore enhanced.

### Third Exemplary Embodiment

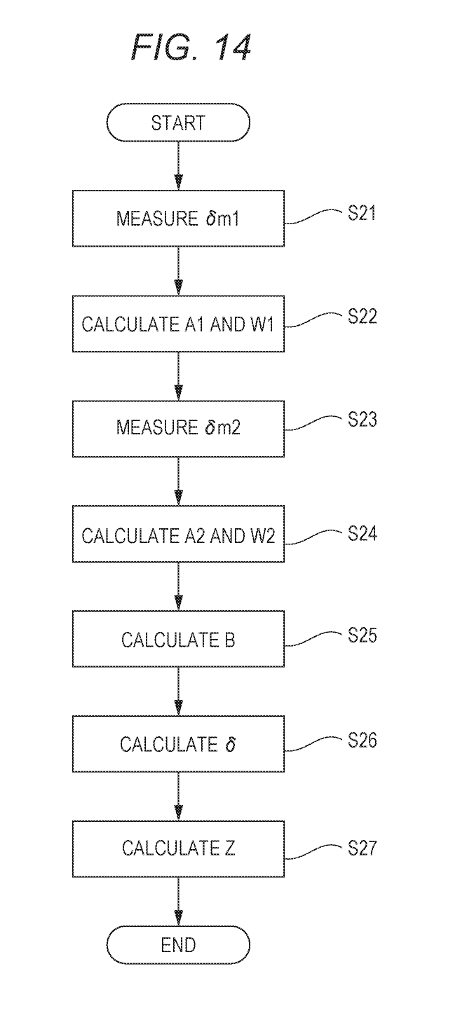

Next, a measurement method in a measurement system according to a third exemplary embodiment of the disclosure will be described. FIG. 14 is a flowchart illustrating a measurement method according to the third exemplary embodiment. The configuration of the measurement system is similar to the first or second exemplary embodiment. In the first and second exemplary embodiments, the description has been given of the case of performing, in the image processing apparatus 400, three-dimensional measurement using a movement amount at an image capturing interval of the robot 110. In the third exemplary embodiment, by measuring a distance between or a size 5M such as a diameter of the two mark members 150₁ and 150₂ in advance, three-dimensional measurement is performed without using information from the robot 110 (the robot control device 120). The measurement method will be specifically described below. In addition, aside from a distance between the mark members 150₁ and 150₂ and the size thereof, a focal length f of the camera 330 is assumed to be also measured in advance by a separate unit.

The case of performing measurement using a distance between the mark members 150₁ and 150₂ will be described below.

First, the image processing apparatus 400 measures the number of pixels δm1 between the mark members 150₁ and 150₂ from the first captured image (S21).

Next, the image processing apparatus 400 obtains, from a distance δM between the mark members 150₁ and 150₂, and the number of pixels δm1, optical magnification (distance for one pixel) A1 of the camera 330 and a working distance W1 on a reference surface including the mark members 150₁ and 150₂ (S22).

In a similar manner, from the second captured image, the image processing apparatus 400 measures the number of pixels δm2 between the mark members 150₁ and 150₂ (S23), and obtains optical magnification A2 of the camera and a working distance W2 (S24).

The image processing apparatus 400 performs image conversion of the second captured image so as to have the same magnification as that of the first captured image, obtains a difference between the positions of the same mark member between the two images, and multiply this by the optical magnification A1 (S25). The value obtained by this calculation corresponds to a movement amount B of the workpiece W. In addition, in a case in which the robot 110 being a conveyance device is adjusted to move the workpiece W along a plane vertical to the light axis, magnification adjustment becomes unnecessary.

The image processing apparatus 400 performs image conversion of the second image so as to have the same magnification as that of the first image, and measures disparity δ of points desired to be measured, between the two images (S26).

Using the focal length f of the camera 330, the movement amount B of the workpiece W, the first optical magnification A1, and the disparity δ of the measurement points that have been obtained, the image processing apparatus 400 calculates a position Z in the light axis direction of a measurement point by a measurement formula Z=A1×δ×f/B of the monocular stereoscopic method (S27).

According to the third exemplary embodiment, three-dimensional measurement can be executed without using the information on the robot 110 side, and without stopping the conveyance of the workpiece W.

In addition, in the case of using the size of the mark members 150₁ and 150₂, similarly to steps S21 to S24, gradients of a reference surface on the first image and a reference surface on the second image can be obtained from the optical magnification in the vicinity of the mark members 150₁ and 150₂. Thus, even if the conveyance direction X of the workpiece W is moving while deviating in the horizontal direction, three-dimensional measurement can be accurately performed.

The disclosure is not limited to the exemplary embodiments described above, and many modifications can be made within the technical concept of the disclosure. In addition, the effects described in the exemplary embodiments of the disclosure are not limited to those described in the exemplary embodiments of the disclosure.

In the above-described exemplary embodiments, the description has been given of a case in which the robot has a six-axis robot arm and a two-finger robot hand. Nevertheless, the number of axes, and the number of fingers are not limited to these numbers. In addition, the description has been given of a case in which a conveyance device is a robot. Nevertheless, the conveyance device is not limited to a robot, and any conveyance device may be used as long as the device can move a workpiece in such a manner that the workpiece passes through the inside of a field angle of a camera.

FIGS. 15A and 15B are schematic diagrams each illustrating another example of a conveyance device. For example, as illustrated in FIG. 15A, a case in which a conveyance device 110A includes a belt conveyor 111A as a conveyance member, and a tray 112A on which the workpiece W is placed, as a holding member may be used. The mark members 150₁ and 150₂ are to be installed on the tray 112A in vicinity of the workpiece W so as to sandwich the workpiece W therebetween.

In addition, the conveyance device needs not to constantly perform position control using a servo. For example, as illustrated in FIG. 15B, a case in which a conveyance device 110B includes a tray 112B on which the workpiece W is placed, as a holding member, and a power giving device 111B such as, for example, a solenoid that gives power to the tray 112B may be used. In this case, a rail 114B is laid so that the tray 112B passes in front of the camera 330. In addition, the tray 112B serving as a holding member may be pushed out by human power without using the power giving device 111B.

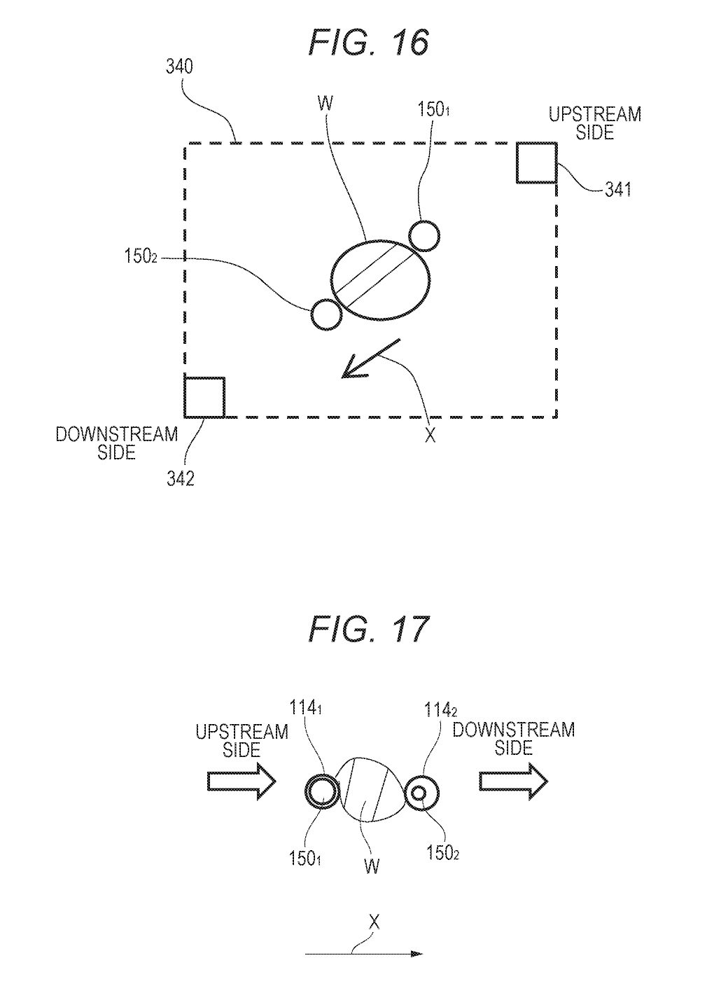

In addition, in the above-described exemplary embodiments, the first pixel region 341 and the second pixel region 342 are assumed to be left and right end portions of the image sensor 340. Nevertheless, pixel regions are not limited to these. Two pixel regions are set according to the conveyance direction of a workpiece and the orientation of an image sensor. FIG. 16 is a schematic diagram illustrating another example of first and second pixel regions. For example, if the image sensor 340 is arranged so that the conveyance direction X of the workpiece W becomes a direction starting from an upper right corner to a lower left corner with respect to the image sensor 340, the first pixel region 341 can be set at the upper right corner of the image sensor 340, and the second pixel region 342 can be set at the lower left corner of the image sensor 340. In this case, because the disparity of two captured images to be used in the monocular stereoscopic method can be made larger, measurement resolution (measurement accuracy) can be enhanced.

In addition, in the above-described exemplary embodiments, the description has been given of a case in which the sizes of the mark members 150₁ and 150₂ are equal. Nevertheless, the sizes of the mark members 150₁ and 150₂ may be different from each other. Because the mark members 150₁ and 150₂ are formed in different sizes, in the first determination processing, the determination circuit 352 determines whether an image of the mark member 150₁ has been captured, based on the size of a mark image in an image acquired from the first pixel region 341.

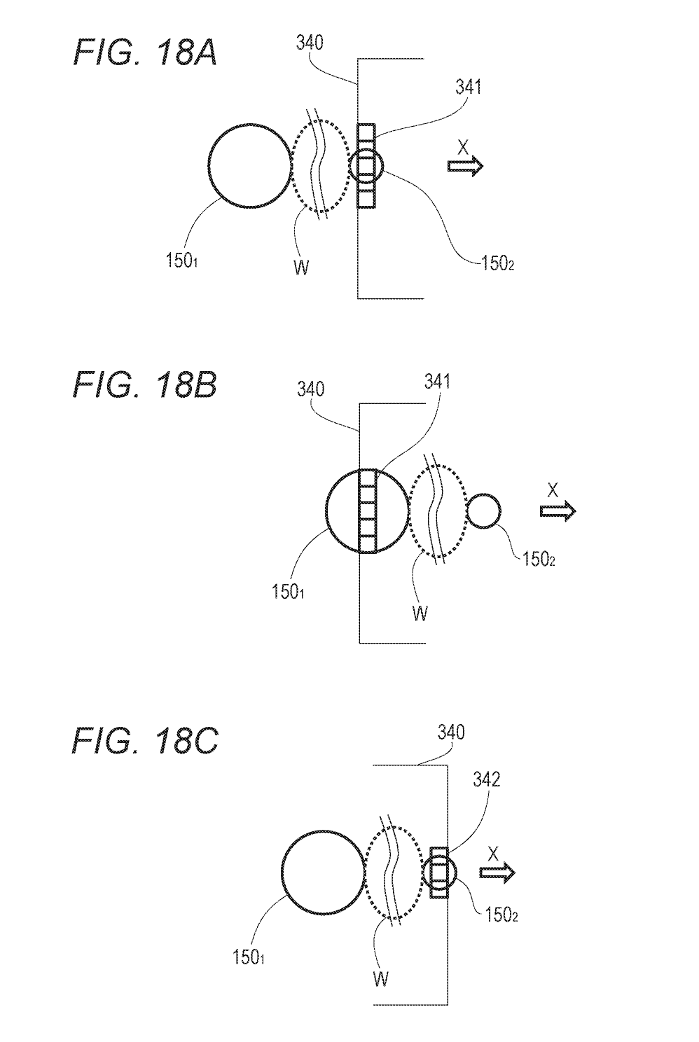

FIG. 17 is a schematic diagram illustrating another example of a mark member. As illustrated in FIG. 17, the mark member 150₁ is formed to be larger than the mark member 150₂. An operation of the determination circuit 352 performed in this case will be described below. FIGS. 18A to 18C are diagrams for illustrating determination processing in the determination circuit.

In the first determination processing (S3 to S5, S13 to S15), the determination circuit 352 counts the number of pixels with pixel data having luminance being equal to or larger than the luminance threshold, in the image data acquired from the first pixel region 341. Then, if the counted number of pixels becomes equal to or larger than a preset first pixel threshold, the determination circuit 352 determines that an image of the mark member 150₁ has been captured.

In addition, in the second determination processing (S8, S18), the determination circuit 352 counts the number of pixels with pixel data having luminance being equal to or larger than the luminance threshold, in the image data acquired from the second pixel region 342. Then, if the counted number of pixels becomes equal to or larger than a preset second pixel threshold, the determination circuit 352 determines that an image of the mark member 150₂ has been captured.

Here, the first pixel threshold can be set to a value suitable for the mark member 150₁, and the second pixel threshold can be set to a value suitable for mark member 150₂ In other words, the first pixel threshold is assumed to be set to a larger value than the second pixel threshold. Thus, as illustrated in FIG. 18A, even if an image of the mark member 150₂ is captured in the first pixel region 341, it is determined through the threshold determination of the number of pixels that the mark image is not the mark member 150₁. Next, as illustrated in FIG. 18B, if an image of the mark member 150₁ is captured in the first pixel region 341, it is determined through the threshold determination of the number of pixels that the mark image is the mark member 150₁.

In the first determination processing, the determination circuit 352 can thereby ignore the mark image of mark member 150₂ through the threshold determination of the number of pixels, and detect the mark image of the mark member 150₁. With this configuration, the ignoring operation processing described in the above-described exemplary embodiments can be omitted.

In addition, as illustrated in FIG. 18C, if the image of the mark member 150₂ that passes earlier is captured in the second pixel region 342, it is determined through the threshold determination of the number of pixels that the mark image is the mark member 150₂.

In the disclosure, if calculation speed does not matter, a circuit that implements one or more functions of the above-described exemplary embodiments may be replaced with a central processing unit (CPU) that executes a program. At this time, the aspect of the embodiments can also be implemented by the processing of supplying a program to a system or an apparatus via a network or a storage medium, and one or more processors in a computer of the system or the apparatus reading and executing the program.

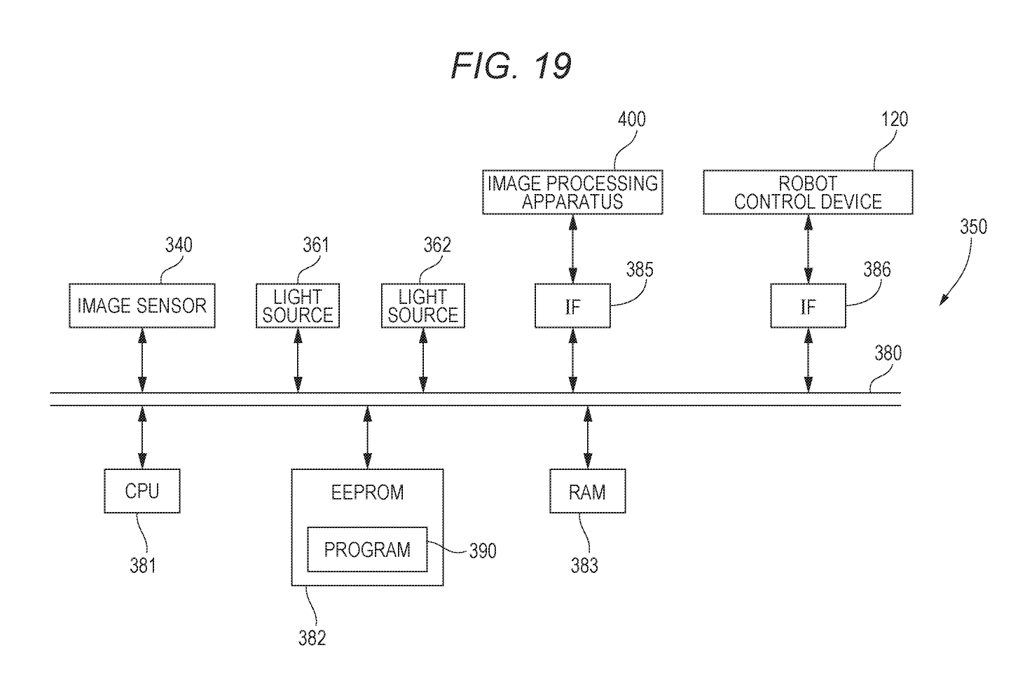

For example, in a case in which a moving speed of a workpiece may be made slow, or in the case of a CPU that can perform processing at a speed equal to or higher than that of a logic circuit, determination using software can be performed. In this case, there is such an advantage that robustness can be enhanced by executing more complicated image processing, and the like. An example in which a control unit is formed by a computer is illustrated in FIG. 19. FIG. 19 is a block diagram illustrating a configuration of a control system of a production system in a case in which a control unit is formed by a computer.

As illustrated in FIG. 19, the control unit 350 includes a CPU 381, an electrically erasable programmable read-only memory (EEPROM) 382, a random access memory (RAM) 383, the image processing apparatus 400 being an external apparatus, and interfaces 385 and 386 to which the robot control device 120 is connected. The EEPROM 382, the RAM 383, the image sensor 340, the light sources 361 and 362, and the interfaces 385 and 386 are connected to the CPU 381 via bus 380. A program 390 for causing the CPU 381 to execute each process of the above-described imaging method is recorded in the EEPROM 382.

Based on the program 390 recorded (stored) in the EEPROM 382, the CPU 381 executes each process of the imaging method by controlling the image sensor 340 and each of the light sources 361 and 362. The RAM 383 is a storage device temporarily storing a calculation result of the CPU 381 and the like.

In addition, in the case of using the CPU 381 as a control unit, a computer-readable recording medium corresponds to the EEPROM 382, and the program 390 is stored in the EEPROM 382. Nevertheless, the configuration is not limited to this. The program 390 may be recorded in any recording medium as long as the recording medium is a computer-readable recording medium. For example, as a recording medium for supplying the program 390, a nonvolatile memory, a recording disc, an external storage device, or the like may be used. As specific examples, a flexible disk, a hard disc, an optical disc, a magneto-photo disk, a compact disk read only memory (CD-ROM), a CD recordable (CD-R), a magnetic tape, a read-only member (ROM), a universal serial bus (USB) memory, or the like can be used as a recording medium.

According to the aspect of the embodiments, two captured images suitable for the monocular stereoscopic method can be obtained with a simple configuration without stopping the conveyance of a workpiece.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2016-045148, filed Mar. 9, 2016, which is hereby incorporated by reference herein in its entirety.

What is claimed is:

1. An imaging system, comprising:
an image sensor having a plurality of pixels; and
a control unit configured to control the image sensor,
wherein the control unit executes:
first imaging processing of obtaining a first image in a first pixel region positioned on an upstream side in a conveyance direction of a target object;
first determination processing of determining, based on the first image, whether an image of a mark on an upstream side in the conveyance direction that has been applied to the target object or a holding member holding the target object has been captured;
first target object imaging processing of obtaining an image of the target object in a case where the image of the mark on the upstream side has been captured;
second imaging processing of obtaining a second image in a second pixel region positioned on a downstream side in the conveyance direction of the target object;
second determination processing of determining, based on the second image, whether an image of a mark on a downstream side in the conveyance direction that has been applied to the target object or the holding member has been captured; and
second target object imaging processing of obtaining an image of the target object in a case where the image of the mark on the downstream side has been captured.

2. The imaging system according to claim 1,
wherein, in the first determination processing, the control unit ignores a mark image that is included for the first time in an image captured in the first pixel region, and determines a mark image that is included for the second time in an image captured in the first pixel region, as the mark on the upstream side.

3. The imaging system according to claim 2,
wherein the control unit determines whether a mark image is included in an image captured in the first pixel region, based on luminance of the image.

4. The imaging system according to claim 3,
wherein, in the first determination processing, the control unit counts a number of pixels with pixel data having luminance being equal to or larger than a preset luminance threshold, in an image acquired from the first pixel region, and in a case in which the number of pixels becomes equal to or larger than the preset pixel threshold for the first time, ignores until the number of pixels becomes equal to or smaller than a lower limit threshold being smaller than the preset pixel threshold, and in a case in which the number of pixels becomes equal to or larger than the pixel threshold again, determines that an image of the mark on the upstream side has been captured.

5. The imaging system according to claim 2,
wherein, in the first determination processing, the control unit determines whether an image of the mark on the upstream side has been captured, based on a size of a mark image in an image acquired from the first pixel region.

6. The imaging system according to claim 5,
wherein the mark on the upstream side is formed to be larger than the mark on the downstream side,
wherein, in the first determination processing, the control unit counts the number of pixels with pixel data having luminance being equal to or larger than a preset luminance threshold, in an image acquired from the first pixel region, and in a case in which the number of pixels becomes equal to or larger than a preset first pixel threshold, determines that an image of the mark on the upstream side has been captured,
wherein, in the second determination processing, the control unit counts the number of pixels with pixel data having luminance being equal to or larger than the luminance threshold, in an image acquired from the second pixel region, and in a case in which the number of pixels becomes equal to or larger than a preset second pixel threshold, determines that an image of the mark on the downstream side has been captured, and
wherein the first pixel threshold is set to a value larger than the second pixel threshold.

7. The imaging system according to claim 1, wherein the control unit includes a logic circuit configured to perform the first determination processing and the second determination processing.

8. The imaging system according to claim 1, further comprising a light source,
wherein the control unit lights the light source in synchronization with an imaging timing in the first target object imaging processing and the second target object imaging processing.

9. The imaging system according to claim 8, further comprising a small light source having a narrower light emission unit area than that of the light source, and
wherein the control unit lights the small light source during image capturing in the first imaging processing and the second imaging processing.

10. A measurement system, comprising:
the imaging system according to claim 1; and
an image processing apparatus configured to three-dimensionally measure the target object, based on two captured images output from the control unit.

11. A production system, comprising:
the measurement system according to claim 10; and
a conveyance member configured to move the holding member holding the target object in the conveyance direction.

12. The production system according to claim 11, wherein the conveyance member is a robot arm, and the holding member is a robot hand.

13. The production system according to claim 11, wherein the mark on the upstream side and the mark on the downstream side are applied to the holding member.

14. The production system according to claim 11, wherein the mark on the upstream side and the mark on the downstream side are formed of a retroreflective member.

15. The production system according to claim 11, further comprising:
an upstream side device configured to supply the target object to the holding member; and
a downstream side device configured to receive the target object from the holding member.

16. An imaging method,
wherein a control unit executes:
a first imaging process of obtaining a first image in a first pixel region positioned on an upstream side in a conveyance direction of a target object;
a first determination process of determining, based on the first image, whether an image of a mark on an upstream side in the conveyance direction that has been applied to the target object or a holding member holding the target object has been captured;
a first target object imaging process of obtaining an image of the target object in a case in which it is determined that the image of the mark on the upstream side has been captured;
a second imaging process of obtaining a second image in a second pixel region positioned on a downstream side in the conveyance direction of the target object;
a second determination process of determining, based on the second image, whether an image of a mark on a downstream side in the conveyance direction that has been applied to the target object or the holding member has been captured; and
a second target object imaging process of capturing an image of the target object in a case in which it is determined that the image of the mark on the downstream side has been captured.

17. A computer-readable recording medium recording a non-transitory program for executing each process of the imaging method according to claim 16.

18. A measurement method for three-dimensionally measuring the target object based on two captured images obtained by the imaging method according to claim 16.
